(19) United States
(12) Patent Application Publication
(10) Pub. No.: US 2020/0362120 A1
(43) Pub. Date: Nov. 19, 2020

(54) COMPOSITION FOR USE IN AN ADDITIVE MANUFACTURING PROCESS

(71) Applicant: EOS GmbH Electro Optical Systems, Krailling (DE)

(72) Inventors: Stoyan Frangov, Muenchen (DE); Andreas Pfister, Muenchen (DE)

(73) Assignee: EOS GmbH Electro Optical Systems, Krailling (DE)

(21) Appl. No.: 16/763,113

(22) PCT Filed: Nov. 13, 2018
(86) PCT No.: PCT/EP2018/081127

§ 371 Date: May 11, 2020

(30) Foreign Application Priority Data
Nov. 14, 2017 (DE) 10 2017 126 773.5
Jun. 29, 2018 (DE) 10 2018 115 876.9

(51) Int. Cl. C08J 3/20; B29C 64/153; B29C 64/40; B33Y 10/00; B33Y 70/10; B33Y 80/00

(52) U.S. Cl. CPC C08J 3/203; B29C 64/153; B29C 64/40; B33Y 10/00; B29K 2071/00; B33Y 80/00; C08J 2323/16; C08J 2379/08; B33Y 70/10

(57) ABSTRACT

The present invention concerns a composition comprising at least one polymer, wherein the polymer is in the form of polymer particles, and wherein the composition contains at least one additive, wherein the additive is in a proportion of at most 2% by weight of the composition. Furthermore, the present invention concerns a method for the production of the composition in accordance with the invention, as well as a method for the production of an article comprising the composition in accordance with the invention. Finally, the present invention concerns the use of the composition in accordance with the invention.

The present invention relates to a composition comprising at least one polymer, wherein the composition contains at least one additive, wherein the additive is in a proportion of at most 2% by weight of the composition. Furthermore, the present invention relates to a method for the production of the composition in accordance with the invention, as well as to an article comprising a composition in accordance with the invention and to the use of the composition in accordance with the invention.

Additive manufacturing processes for the production of prototypes and the industrial fabrication of articles which operate on the basis of powdered substances enable sculptural objects to be produced and are steadily growing in importance. In the fabrication process, the desired structures are produced in layers by selective melting and consolidation or by applying a binder and/or adhesive. The process is also described as “additive manufacturing”, “digital fabrication” or “three-dimensional (3D) printing”.

Processes have been used for decades in industrial development processes in order to produce prototypes (rapid protoyping). However, technological advances in the systems also meant that a start was made on fabricating parts which satisfied the quality requirements for a finished product (rapid manufacturing).

In practice, the term “additive manufacturing” is also replaced by “generative fabrication” or “rapid technology”. Examples of additive manufacturing processes which use a powdered substance are sintering, melting or bonding using binders.

Frequently, polymer systems are used as the powdered substances for the production of shaped articles. Industrial users of systems of this type demand good processability, good shape accuracy and good mechanical properties for shaped articles produced by them.

During the production of 3D components, crystallization of the polymer is initiated during cooling. However, the crystallization process is always associated with geometrical variations, shrinkage and frequently warping of the 3D component. Delaying crystallization, i.e. a reduction at the temperature at which the polymer crystallizes, is also advantageous in order to obtain binding of the layer in the melt with the underlying component layers, because interdiffusion between the layers can only occur in the melt. In the case of insufficient layer adhesion due to premature crystallization, finished 3D components have a tendency to delaminate and lose strength. The build chamber temperature during the production process should be controlled as much as possible so that crystallization of the polymer during the construction process is suppressed for as long as possible. If this is not successful, process defects such as warping, for example, occur during the production.

Thus, during the production of 3D components, on the one hand the build chamber temperature must be above the crystallization temperature of the relevant polymer, and on the other hand the temperature must be below the melting point because otherwise, the powder cake would melt in the build chamber. The range of temperatures between the crystallization temperature (TK) and the melting temperature (TM) is known as the process window or the sintering window of the polymer. If crystallization and melting of a polymer overlap by a large proportion along the temperature axis, then this polymer will very probably not be able to be used in the process, i.e. the process window is not sufficient.

In order to tailor the properties of a material, for example a polymer system, in a manner such that it is suitable for additive manufacturing processes, in addition, additives often have to be added. Such additives often result in undesirable properties such as, for example, an unfavourable melting behaviour due to a reduction of the process window, i.e. the temperature range within which the polymer system can be worked. In addition, the crystallization temperature of the polymer, for example due to the addition of anti-caking agents or anti-agglomeration agents, can be raised in an unwanted manner, whereupon again, the process window shrinks.

Examples of further unwanted effects when adding additives can manifest themselves in a tendency to warp or an insufficient dimensional tolerance of the components, whereupon the use of the additives or systems with such additives in additive manufacturing processes is severely restricted.

Thus, the objective of the present invention is to provide a composition which preferably is suitable for use in additive manufacturing processes as a substance for the production of shaped articles with a reliable mechanical stability and high shape accuracy. In particular, one objective of the present invention is to provide a composition which has a large process window.

In accordance with the invention, this objective is achieved by means of a composition in accordance with claim 1, which comprises at least one polymer and at least one additive.

Furthermore, the objective is achieved by means of a method for the production of the composition in accordance with claim 16, by means of a method for the production of an article in accordance with claim 17, as well as by means of a use of the composition of the invention in accordance with claim 20.

The present invention therefore concerns a composition, in particular for use as a construction material for additive manufacturing as mentioned above, comprising
(a) at least one polymer,
wherein the polymer is in the form of polymer particles and wherein the polymer is selected from at least one thermoplastic polymer, and
(b) at least one additive,
wherein the at least one additive is in a proportion of at least 0.005% by weight, preferably at least 0.01% by weight, particularly preferably at least 0.05% by weight, in particular at least 0.075% by weight, particularly preferably at least 0.1% by weight, yet more preferably at least 0.2% by weight of the composition,
and/or
wherein the additive is in a proportion of at most 2% by weight, preferably at most 1.5% by weight, particularly preferably at most 1% by weight, in particular at most 0.7% by weight, particularly preferably at most 0.5% by weight of the composition.

In its simplest embodiment, a composition in accordance with the invention comprises a polymer or a polymer system which is selected from a thermoplastic polymer and an additive.

The term “additive” as used herein should be understood to mean a material which in particular may be an amorphous and/or semicrystalline and/or crystalline polymer, a polyol, a surfactant and/or a protective colloid which, even in very low concentrations of up to 2% by weight, enables the crystallization temperature and/or crystallization enthalpy of the thermoplastic polymer to be reduced. In particular, the crystallization enthalpy can be reduced by a percentage which is higher in relative terms than the concentration of the additive. The ratio of the crystallization enthalpy to the concentration of the additive is advantageously 10%, preferably 20%, particularly preferably 50% and in particular 100% higher.

Preferably, the additive is a semicrystalline polymer, a semicrystalline polyol and/or a semicrystalline surfactant and/or a semicrystalline protective colloid. Preferably, the additive is soluble in water at room temperature. In particular, an additive has a solubility of at least approximately 30 g/L of water.

Preferably, the composition in accordance with the invention is in the form of a powder.

In accordance with the invention, the composition has an additive content of at least 0.005% by weight, preferably at least 0.01% by weight, particularly preferably at least 0.05% by weight, in particular at least 0.075% by weight, particularly preferably at least 0.1% by weight, more particularly preferably at least 0.2% by weight of the composition, and/or the composition an additive content of at most 2% by weight, preferably at most 1.5% by weight, particularly preferably at most 1% by weight, in particular at most 0.7% by weight, particularly preferably at most 0.5% by weight. Methods for determining the additive content in the composition or the polymer are known to the person skilled in the art and may, for example, be carried out by means of DSC (Differential Scanning Calorimetry, DIN EN ISO 11357). The additive in this regard is preferably bound to the polymer or the polymer particle, for example deposited on its surface.

In accordance with the invention, such a proportion of an additive to the composition or the polymer can produce a reduction in the crystallization temperature and/or an increase in the difference ΔTK/TM between the crystallization temperature (TK) and the melting temperature (TM), i.e. a broadening of the process window. Reference to the crystallization temperature and melting temperature should be understood to mean the peak temperature as defined in DIN EN ISO 11357.

Methods for determining the crystallization temperature and melting temperature are known to the person skilled in the art and can usually be measured with the aid of differential scanning calorimetry (DSC) in accordance with DIN EN ISO 11357. In order to ensure a comparability of the measurements of the polymer with and without additive, the determination using DSC is carried out in a manner such that the same methods are employed, using the same hold times, heating rates, start temperatures and end temperatures.

The degree of crystallization can be measured using different analytical methods such as by means of DSC, for example. In this regard, the degree of crystallization is calculated via the melting enthalpy [J/g] (compared with a polymer which is theoretically 100% crystalline). The term “melting enthalpy” should be understood to mean the quantity of energy which is necessary to melt a sample of material at its melting point under constant pressure (isobaric), i.e. to transform it from the solid to the liquid physical state.

Too high an additive content in this regard, however, leads to disadvantageous agglutination and/or caking effects in the polymer particles, whereupon the pourability and the processability of the particles are severely compromised. Surprisingly, it has now been discovered that a content of at most 2% by weight of the additive in the composition in accordance with the invention effectively prevents agglutination and/or caking effects and thus at the same time advantageously improves the pouring properties.

Furthermore, the composition in accordance with the invention guarantees for a homogeneous powder structure, so that in this manner, an improved flowability or pourability and thus, during the course of additive manufacturing processes, uniform powder application, is enabled thereby. A good flowability for a bulk material is obtained when the bulk material can easily be caused to flow. The most important parameter in this regard is the pourability, i.e. the measure of the unrestricted mobility of the bulk material.

The term “polymer” or “polymer system” as used in the present patent application should be understood to mean at least one homopolymer and/or a heteropolymer which is constructed from a plurality of monomers. While homopolymers have a covalent concatenation of identical monomers, heteropolymers (also known as copolymers) are constructed from covalent concatenations of different monomers. In this regard, a polymer system in accordance with the present invention may include both a mixture of the aforementioned homopolymers and/or heteropolymers, or also more than one polymer system. A mixture of this type may also be described in the present patent application as a polymer blend.

In the context of the present invention, heteropolymers are herein selected from random copolymers in which the distribution of the two monomers in the chain is randomized, from gradient copolymers, which in principle are similar to random copolymers, but in which the proportion of one monomer along the chain increases and that of the other decreases, from alternating copolymers, in which the monomers alternate, from block copolymers or segment copolymers, which consist of longer sequences or blocks of each monomer, and from graft copolymers, in which blocks of one monomer are grafted onto the framework (backbone) of another monomer.

Advantageously, the composition in accordance with the invention can be used for additive manufacturing processes. In particular, additive manufacturing processes include processes which are suitable for the manufacture of prototypes (rapid prototyping) and components (rapid manufacturing), preferably from the powder bed-based group of processes comprising laser sintering, high speed sintering, multi-jet fusion, binder jetting, selective mask sintering or selective laser melting. In particular, however, the composition in accordance with the invention is intended for use for laser sintering. The term “laser sintering” in this regard should be understood to mean the same as the term “selective laser sintering”; the latter is simply the older designation.

Furthermore, the present invention concerns a method for the production of a composition in accordance with the invention, wherein the method comprises the following steps:
(i) providing at least one polymer, wherein the polymer is selected from at least one thermoplastic polymer,
(ii) mixing, preferably dispersing, the polymer with an additive,
(iii) removing, in particular separating, the additive in order to obtain a composition,
wherein the composition has a content of the at least one additive of at least 0.005% by weight, preferably at least 0.01% by weight, particularly preferably at least 0.05% by weight, in particular at least 0.075% by weight, particularly preferably at least 0.1% by weight, more particularly preferably at least 0.2% by weight of the composition,
and/or
wherein the composition has a content of the additive of at most 2% by weight, preferably at most 1.5% by weight, particularly preferably at most 1% by weight, in particular at most 0.7% by weight, particularly preferably at most 0.5% by weight.

The term “provide” as used herein means both in situ manufacture as well as supplying a polymer or a polymer system.

The terms “mixing”, “admixing”, “blending” and “compounding” as used below should be understood to be synonymous. A mixing, admixing, blending or compounding procedure may in this regard be carried out during the course of extrusion in an extruder, a kneader or a disperser and/or in a stirrer and optionally includes process operations such as, for example, melting, dispersion, etc. Preferably, the mixing procedure is carried out in an extruder, particularly preferably by melt extrusion.

Alternatively, the procedure for mixing the polymer with an additive, preferably in the melt, may be carried out in a kneader. However, preferably, the mixing procedure is carried out in an extruder, in particular by melt extrusion.

Preferably, the additive is removed or separated by means of centrifuging and/or filtration.

If the composition in accordance with the invention is packaged, then a packaging procedure is advantageously carried out with the exclusion of moisture.

A composition manufactured according to the method in accordance with the invention is thus advantageously used as a consolidatable powdered material in a method for the layered production of a three-dimensional object from powdered material, in which successive layers of the object to be formed are solidified from this consolidatable powdered material one after the other at appropriate or predetermined locations by the input of energy, preferably of electromagnetic radiation, in particular by the input of laser light.

The present invention also encompasses a composition, in particular for a laser sintering process, which can be obtained or is obtainable using the method described above.

Finally, a composition in accordance with the invention is used for the production of an article, in particular a three-dimensional object, by application in layers and selective consolidation of a construction material, preferably a powder. The term “consolidation” in this regard should be understood to mean at least partial melting with subsequent solidification or re-consolidation of the construction material.

In this regard, an advantageous method has at least the following steps:
(i) applying a layer of a composition in accordance with the invention and/or a composition produced according to a method in accordance with the invention, preferably a powder, to a build chamber,
(ii) selectively consolidating the applied layer of the composition at locations which correspond to a cross section of the object to be produced, preferably by means of an irradiation unit, and
(iii) dropping the support and repeating the steps of application and consolidation until the article, in particular the three-dimensional object, is completed.

The term “construction material” as used in the present patent application should be understood to mean a powder or a consolidatable powdered material which can be consolidated by means of additive manufacturing processes, in particular by means of laser sintering or laser melting, to form shaped articles or 3D objects. The composition in accordance with the invention is particularly suitable as a construction material of this type.

The “build chamber” in this regard is a plane which is located on a support within a machine for additive manufacturing at a specific distance from an overhead irradiation unit which is suitable for consolidation of the construction material. The construction material is positioned on the support in a manner such that its uppermost layer is aligned with the plane which is to be consolidated. In this regard, the support can be adjusted during the fabrication process, in particular laser sintering, in a manner such that each newly applied layer of the construction material is at the same distance from the irradiation unit, preferably a laser. and in this manner, can be consolidated by the action of the irradiation unit.

A component, in particular a 3D object which has been produced from the composition in accordance with the invention, has an advantageous tensile strength and elongation at break. In this regard, the tensile strength characterizes the maximum mechanical tensile stress which can occur in the substance. The determination of the tensile strength is known to the person skilled in the art and it can, for example, be determined in accordance with DIN EN ISO 527. The elongation at break characterizes the deformability of a substance in the plastic region (also known as the ductility) to breakage and can, for example, be determined by means of DIN EN ISO 527-2.

Furthermore a component which has been produced from the composition in accordance with the invention has an improved dimensional tolerance and/or a reduced warping of the component. In this regard, the term “dimensional tolerance” should be understood to mean that the actual measurement of a workpiece is within the agreed permissible deviations or tolerances from the set nominal measurement. In the laser sintering process, this dimensional tolerance can preferably be determined by means of the warping of the component. Furthermore, the term “stability” of a workpiece is used with respect to the expansion and contraction. Examples of frequent causes of variations in measurements are temperature, pressure or tensile forces, ageing and moisture.

The present invention also encompasses a component which can be obtained or is obtained using the method described above.

The composition in accordance with the invention may be used both in rapid prototyping and also in rapid manufacturing. In this regard, for example, additive manufacturing processes are used, preferably from the group formed by powder bed-based processes including laser sintering, high speed sintering, binder jetting, selective mask sintering, selective laser melting, in particular used for laser sintering, in which preferably, three-dimensional objects are formed in layers by selective projection of a laser beam with a desired energy onto a powder bed formed from powdered substances. Prototypes or fabricated parts can be produced using this process in a manner which is efficient both as regards time and costs.

The term “rapid manufacturing” in particular means processes for the production of components, i.e. the production of more than one identical part, in which, otherwise, the production, for example by means of an injection moulding tool, would not be economic or would be impossible because of the geometry of the component, especially when the parts have a very complicated shape. Examples in this regard are parts for high quality vehicles, racing vehicles or rally vehicles which are only produced in small numbers, or replacement parts for motor sports in which, in addition to the small numbers, the timing of the availability also plays a role. Examples of areas where the parts in accordance with the invention could be used are the aircraft and spacecraft industries, medical technology, mechanical engineering, automotive engineering, the sports industry, the household goods industry, the electronics industry, or the lifestyle industry. The production of a plurality of similar components, for example of personalized components such as prostheses, (inner ear) hearing aids and the like, with a geometry that can be individually tailored to the wearer, is also a significant area.

Finally, the present invention encompasses a composition formed from a consolidatable powder material in a process for the layered production of a three-dimensional object from powdered material, in which successive layers of the object to be formed from this consolidatable powdered material are consolidated in succession at appropriate locations by the input of energy, preferably by the input of electromagnetic radiation, in particular by the input of laser light.

Further particularly advantageous embodiments and variations of the invention will become apparent from the dependent claims as well as from the description below, wherein the patent claims of a specific category may also be varied in accordance with the dependent claims of another category and features of the various exemplary embodiments can be combined to form new exemplary embodiments.

As already discussed, the composition in accordance with the invention comprises at least one additive. Preferably, an additive of this type is immiscible with the at least one thermoplastic polymer.

In accordance with a preferred embodiment, the at least one additive is selected from a semicrystalline polymer (such as, for example, polyvinyl acetate, polyvinyl alcohol, polyvinyl pyrrolidone), a semicrystalline cellulose ether (such as, for example, methyl cellulose, hydroxyethyl cellulose, hydroxypropylmethyl cellulose) and/or a semicrystalline polyacrylate, a semicrystalline starch, a semicrystalline protein, a semicrystalline alginate, a semicrystalline pectin and/or a semicrystalline gelatine.

In accordance with a particularly preferred embodiment, the additive is selected from at least one polyol, in particular from a semicrystalline polyol. Particularly preferably, a polyol of this type is selected form at least one semicrystalline polyethylene glycol and/or from at least one semicrystalline polyethylene oxide and/or from at least one polyvinyl alcohol, particularly preferably from at least one semicrystalline polyethylene glycol. In particular in this regard, a polyethylene glycol comprises a mixture of at least two semicrystalline polyethylene glycols, which preferably have different molecular weights. The use of polyethylene glycols with different molecular weights in this regard advantageously serves to obtain a suitable viscosity.

Preferably, the at least one preferably semicrystalline polyethylene glycol has a molecular weight of at least 10000 D, preferably at least 15000 D, particularly preferably at least 20000 D and/or of most 500000 D, preferably at most 250000 D, particularly preferably at most 100000 D, in particular at most 40000 D, particularly preferably at most 35000 D.

A particularly preferred additive comprises a mixture of at least two semicrystalline polyethylene glycols with a polyethylene glycol with a molecular weight of 20000 D and a polyethylene glycol with a molecular weight of 500000 D, or also a mixture of a polyethylene glycol with a molecular weight of 35000 D and a polyethylene glycol with a molecular weight of 100000 D, in particular a mixture of a polyethylene glycol with a molecular weight of 20000 D and a polyethylene glycol with a molecular weight of 35000 D.

More preferably, the additive is selected from a surfactant such as, for example, from at least one non-ionic organic surfactant and/or polymeric surfactant. In particular, the surfactant is selected from sodium dodecyl sulphate. In particular, a preferred surfactant is in the semicrystalline form.

If an advantageous composition comprises more than one additive, then the proportions of the individual additives are added in a manner such that their sum generates the proportion in accordance with the invention as specified above.

In accordance with a particularly preferred embodiment, an advantageous composition has a crystallization temperature which is reduced by at least 2° C., preferably at least 3° C., particularly preferably at least 4° C., in particular at least 5° C. compared with the thermoplastic polymer without additive and/or has a difference ΔTK/TM between the crystallization temperature (TK) and the melting temperature (TM) which is higher by at least 1° C., preferably at least 3° C., particularly preferably at least 5° C.

In accordance with a further preferred embodiment, an advantageous composition has a melting enthalpy of at least 20 J/g, preferably at least 40 J/g, in particular at least 60 J/g. At most, an advantageous composition has a melting enthalpy of up to 150 J/g, preferably up to 140 J/g, in particular up to 130 J/g. An advantageous composition of this type enables better differentiation of the component from unsintered powder because in this manner, fewer of the powder particles bordering the component are melted. Furthermore, by means of such an advantageous melting enthalpy, a higher construction temperature and thus a broader process window are produced.

In accordance with a preferred embodiment, an advantageous composition comprises a thermoplastic polymer which is selected from at least one polyetherimide, polycarbonate, polysulphone, polyphenylene sulphone, polyphenylene oxide, polyethersulphone, acrylonitrile-butadiene-styrene copolymer (ABS), acrylonitrile-styrene-acrylate copolymer (ASA), polyvinyl chloride, polyacrylate, polyester, polyamide, polypropylene, polyethylene, polyaryl ether ketone, polyether, polyurethane, polyimide, polyamide imide, polyolefin, polyarylene sulphide, as well as their copolymers. Particularly preferably, the polymer comprises a polyamide and/or a polypropylene.

The at least one polymer in this regard is preferably selected from at least one homo- and/or heteropolymer and/or from a polymer blend, wherein the at least one homo- and/or heteropolymer and/or polymer blend particularly preferably comprises a semicrystalline homo- and/or heteropolymer and/or amorphous homo- and/or heteropolymer. In particular, the at least one homo- and/or heteropolymer and/or polymer blend is selected from at least one semicrystalline polymer or from a semicrystalline polymer blend of at least one semicrystalline polymer, and at least one further semicrystalline polymer, or from a semicrystalline polymer blend of at least one semicrystalline polymer and an amorphous polymer.

The term “semicrystalline” as used in the present case should be understood to mean a material which contains both crystalline and amorphous regions. A polymer is considered to be essentially amorphous when its degree of crystallinity in the solid state is 5% by weight or less, in particular 2% by weight or less. A polymer is in particular considered to be essentially amorphous when, by means of differential scanning calorimetry (DSC), no melting point can be observed and/or the melting enthalpy is below 1 J/g. Finally, a semicrystalline material, can contain up to 95% by weight, preferably up to 99% by weight, in particular up to 99.9% by weight, of crystalline regions.

Preferably, the heteropolymer or copolymer has at least two different repeat units and/or at least one polymer blend on the basis of the cited polymers and copolymers. Preferably, a heteropolymer or copolymer and/or polymer blend of this type is semicrystalline.

By using one or more of the cited polymers (homopolymers, copolymers or polymer blends), a powdered material can be produced which is at least partially semicrystalline.

Preferably, a composition in accordance with the invention comprises a polymer and/or a copolymer and/or a polymer blend with a melting temperature of at least approximately 50° C., preferably at least approximately 100° C. The highest melting temperature of the polymer and/or the copolymer and/or the polymer blend in this regard is at most approximately 400° C., preferably at most approximately 350° C. The term “melting temperature” in this regard should be understood to mean the temperature or the range of temperatures at which a material, preferably a polymer or copolymer or polymer blend, is transformed from the solid to the liquid physical state.

When the term “at least approximately” or “at most approximately” or “up to approximately” (etc) is used in the present text, this means that the cited numerical value may vary by 10 % to 15%.

In accordance with a particularly preferred embodiment, the composition in accordance with the invention comprises a polymer or a polymer system which is preferably selected from at least one polypropylene and/or a polyamide.

Polypropylene (PP, synonymous with polypropene, poly(1-methylethylene)), is a thermoplastic polymer which can be produced by chain polymerization of propene. It belongs to the polyolefins group and is in general semicrystalline and nonpolar.

In this regard, the at least one polypropylene can in principle exist in an atactic, syndiotactic and/or isotactic form. In the case of atactic polypropylene, the methyl groups are orientated in a random manner; with syndiotactic polypropylene, they alternate, and with isotactic polypropylene, they are orientated uniformly. This can influence the crystallinity (amorphous or semicrystalline) and the thermal properties (such as, for example, the glass transition temperature and the melting temperature). The tacticity is usually given as a percentage with the aid of the isotactic index (in accordance with DIN 16774). Particularly preferably, the polypropylene is selected from an isotactic polypropylene.

Furthermore, the at least one preferred polypropylene may be selected from an isotactic polypropylene and/or its copolymers with polyethylene or with maleic acid anhydride. Particularly preferably in this regard, the proportion of polyethylene in the copolymer is up to 50% by weight, particularly preferably up to 30% by weight.

More preferably, at least one polymer blend of polypropylene with at least one ethylene-vinyl acetate copolymer may be used. A polymer blend of this type advantageously has a higher impact strength, i.e. the ability to absorb impact energy and kinetic energy without breaking.

When a composition in accordance with the invention comprises a polymer which is selected from a polypropylene, in particular from an isotactic polypropylene, the additive content in this composition is preferably at least 0.005% by weight, preferably at least 0.01% by weight, particularly preferably at least 0.05% by weight, in particular at least 0.075% by weight, particularly preferably at least 0.1% by weight, more particularly preferably at least 0.2% by weight, and/or at most 2% by weight, preferably at most 1.5% by weight, particularly preferably at most 1% by weight, in particular at most 0.7% by weight, particularly preferably at most 0.5% by weight. Particularly preferably, the polypropylene is selected from a polypropylene-polyethylene copolymer.

Polyamides (PA) are linear polymers with regularly repeating amide bonds along the main chain. The amide group can be construed as a condensation product of a carboxylic acid and an amine. The resulting bond is an amide bond, which can be split again hydrolytically. The designation “polyamide” is usually used to designate synthetic, technologically useful thermoplastic polymers.

When a composition in accordance with the invention comprises a polymer which is selected from a polyamide, the additive content in this composition is preferably at least 0.005% by weight, particularly preferably at least 0.01% by weight and/or preferably at most 0.9% by weight, particularly preferably at most 0.8% by weight, in particular at most 0.7% by weight.

Preferably, the at least one polyamide is selected from polyamide 6, polyamide 11, polyamide 12, polyamide 46, polyamide 66, polyamide 1010, polyamide 1012, polyamide 1112, polyamide 1212, polyamide PA6T/6I, poly-m-xylylene adipamide (PA MXD6), polyamide 6/6T, polyamide PA6T/66, PA4T/46 and/or Platamid M1757.

In accordance with a further preferred composition, the thermoplastic polymer is selected from at least one polyaryl ether ketone from the group formed by polyether ketone ketone (PEKK) and/or from the group formed by polyether ether ketone-polyether diphenyl ether ketone (PEEK-PEDEK).

A further preferred embodiment in this regard comprises a polyether ether ketone-polyether diphenyl ether ketone (PEEK-PEDEK) with the following repeat units:

repeat unit A

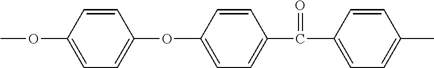

and/or repeat unit B

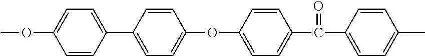

Said polyether ether ketone-polyether diphenyl ether ketone polymer may in this regard have a molar proportion of at least 68 mol %, preferably at least 71 mol %, of the repeat unit A. Particularly preferred polyether ether ketone-polyether diphenyl ether ketone polymers have a molar proportion of at least 71 mol % or, more preferably, of at least 74 mol %, of the repeat unit A. Said polyether ether ketone-polyether diphenyl ether ketone polymer preferably has a molar proportion of less than 90 mol %, more preferably 82 mol % or less of the repeat unit A. Furthermore, said polymer comprises a preferred molar proportion of at least 68 mol %, particularly preferably at least 70 mol %, in particular at least 72 mol %, of the repeat unit A. At most, the polyether ether ketone-polyether diphenyl ether ketone polymer has a preferred molar proportion of 82 mol %, particularly preferably at most 80 mol %, in particular at most 77 mol %, of the repeat unit A.

In this regard, the ratio of the repeat unit A to the repeat unit B is preferably at least 65 to 35 and/or at most 95 to 5.

In this regard, the number of repeat units A and B may preferably be at least 10 and/or at most 2000. Preferably, the molecular weight (MW) of such a polyether ether ketone-polyether diphenyl ether ketone is at least 10000 D (Dalton, synonymous with Da), particularly preferably at least 15000 D and/or at most 200000 D, in particular at least 15000 D and/or at most 100000 D. The mass average molecular weight of such a preferred polymer is preferably at least 20000 D, particularly preferably at least 30000 D and/or at most 500000 D, in particular at least 30000 D and/or at most 200000 D.

When reference is made in the present invention to the molecular weight, this refers to the number average molecular weight. If the mass average molecular weight is to be referred to, this will be specifically stated.

In this regard, a further preferred composition comprises a polyether ketone ketone with the following repeat units:
repeat unit A:

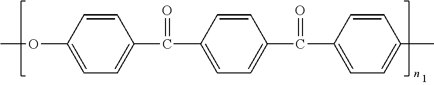

repeat unit B:

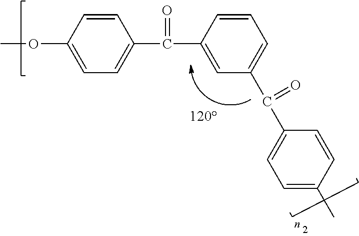

Preferably in this regard, the ratio of 1,4-phenylene units in repeat unit A to 1,3-phenylene units in repeat unit B is 90 to 10 up to 10 to 90, particularly preferably 70 to 30 up to 10 to 90, in particular 60 to 40 up to 10 to 90, particularly preferably from approximately 60 to approximately 40. The number n₁ or n₂ of repeat units A or repeat units B in this regard is preferably at least 10 and/or up to at most 2000.

Preferably, the molecular weight of such a polyether ketone ketone is at least 10000 D, particularly preferably at least 15000 D and/or at most 200000 D, in particular at least 15000 D and/or at most 100000 D. The mass average molecular weight of such a preferred polymer is preferably at least 20000 D, particularly preferably at least 30000 D and/or at most 500000 D, in particular at least 30000 D and/or at most 200000 D.

A preferred polyether ether ketone polymer may, for example, be obtained under the trade name Kepstan, from the 6000 series (for example Kepstan 6001, 6002, 6003 or 6004, Arkema, France).

In accordance with a further preferred embodiment, the melting temperature of the at least one polyaryl ether ketone is up to 330° C., preferably up to 320° C., in particular up to 310° C. The lowest melting temperature of the at least one polyaryl ether ketone is 250° C.

The glass transition temperature of the at least one polyaryl ether ketone is preferably at least 120° C., preferably at least 140° C., in particular at least 160° C. The term “glass transition temperature” in this regard should be understood to mean the temperature at which a polymer is transformed from a rubbery to a viscous state. The determination of the glass transition temperature is known to the person skilled in the art and can, for example be carried out using DSC in accordance with DIN EN ISO 11357.

The low melting temperature or glass transition temperature of the at least one polyaryl ether ketone advantageously authorizes a low processing temperature, in particular for laser sintering, as well as little ageing or an improved refreshment rate for the composition.

The term “refreshment rate” in this regard should be understood to mean the ratio of fresh powder to used powder. When using the said composition, advantageously, the refreshment rate is improved or the ageing is substantially reduced, and therefore a loss of unused powder is significantly reduced, whereupon finally, the economics of production of a shaped article from the advantageous composition are significantly improved.

In accordance with a further preferred composition, the thermoplastic polymer is selected from at least one polyetherimide. Particularly preferably in this regard, the polyetherimide has repeat units in accordance with

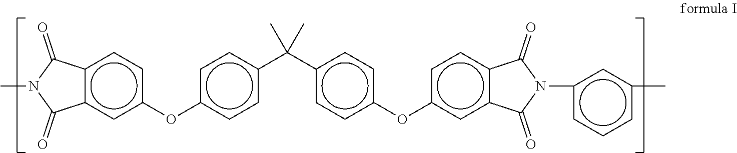

and/or repeat units in accordance with

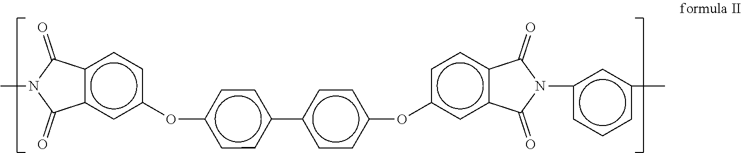

and/or with repeat units in accordance with

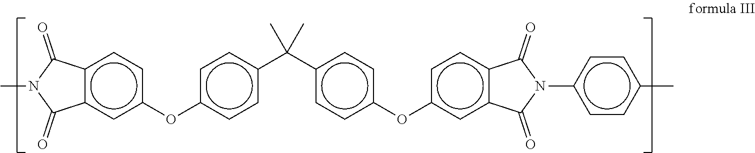

The number n of repeat units in accordance with formulae I, II and III in this regard is preferably at least 10 and/or up to at most 1000.

Preferably, the molecular weight of such a polyetherimide is at least 10000 D, particularly preferably at least 15000 D and/or at most 200000 D, in particular at least 15000 D and/or at most 100000 D. The mass average molecular weight of such a preferred polymer is preferably at least 20000 D, particularly preferably at least 30000 D and/or at most 500000 D, in particular at least 30000 D and/or at most 200000 D.

An example of a preferred polyetherimide in accordance with formula I is available under the trade name Ultem® 1000, Ultem® 1010 and Ultem® 1040 (Sabic, Germany). An example of a preferred polyetherimide in accordance with formula II is available under the trade name Ultem® 5001 and Ultem® 5011 (Sabic, Germany).

A further preferred composition comprises a thermoplastic polymer which is selected from at least one polycarbonate. Particularly preferably in this regard, the polycarbonate has repeat units in accordance with

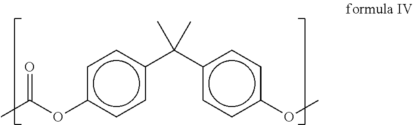

The number n of the repeat units in accordance with formula IV in this regard is preferably at least 20 and/or up to at most 2000.

Preferably, the molecular weight of such a polycarbonate is at least 10000 D, particularly preferably at least 15000 D and/or at most 200000 D, in particular at least 15000 D and/or at most 100000 D. The mass average molecular weight of such a preferred polymer is preferably at least 20000 D, particularly preferably at least 30000 D and/or at most 500000 D, in particular at least 30000 D and/or at most 200000 D.

An example of a polycarbonate which is suitable for use as a starting material is marketed by Sabic under the trade name Lexan® (for example “Lexan® 143R”) or by Covestro under the trade name Makrolon®.

In accordance with a further preferred composition, the thermoplastic polymer is selected from polyarylene sulphide. Preferably in this regard, the polyarylene sulphide has a polyphenylene sulphide with repeat units in accordance with

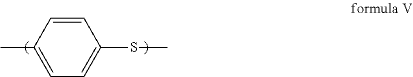

The number n of the repeat units in accordance with formula V in this regard is preferably at least 50 and/or up to at most 5000.

Preferably, the molecular weight of such a polyphenylene sulphide is at least 10000 D, particularly preferably at least 15000 D and/or at most 200000 D, in particular at least 15000 D and/or at most 100000 D. The mass average molecular weight of such a preferred polymer is preferably at least 20000 D, particularly preferably at least 30000 D and/or at most 500000 D, in particular at least 30000 D and/or at most 200000 D.

An example of a preferred polyphenylene sulphide is available from Celanese (Germany) under the trade name Fortron®.

In particular, an advantageous composition may contain a polymer blend comprising a polyaryl ether ketone-polyetherimide, a polyaryl ether ketone-polyetherimide-polycarbonate, a polyphenylene sulphide-polyetherimide and/or a polyetherimide-polycarbonate. A polymer blend of this type may, for example, be obtained from Sabic (Germany) under the trade mark Ultem® 9085.

A further preferred composition in this regard comprises a polymer blend comprising a polyaryl ether ketone-polyetherimide, preferably a polyether ketone ketone with a ratio of repeat unit A to repeat unit B of 60 to 40. In this regard, a preferred composition may comprise a polyetherimide which preferably contains the repeat units of formula I.

Furthermore, a preferred composition may comprise a polymer blend comprising a polyphenylene sulphide-polyetherimide, preferably a polyphenylene sulphide with formula V and a polyetherimide with formula I.

Finally, a preferred composition may comprise a polycarbonate, in particular with the repeat unit of formula IV, and/or a polyphenylene sulphide, in particular with the repeat unit of formula V.

In accordance with a further preferred embodiment, an advantageous composition comprises at least one auxiliary material, wherein the auxiliary material is preferably selected from heat stabilizers, oxidation stabilizers, UV stabilizers, fillers, colorants, plasticizers, reinforcing fibres, IR absorbers, SiO₂ particles, anti-agglomeration agents, carbon black particles, carbon fibres, glass fibres, carbon nanotubes, mineral fibres (for example wollastonite), aramid fibres (in particular Kevlar fibres), glass beads, mineral fillers, inorganic and/or organic pigments and/or flame retardants (in particular phosphate-containing flame retardants such as ammonium polyphosphate and/or bromine-containing flame retardants and/or other halogenated flame retardants and/or inorganic flame retardants such as magnesium hydroxide or aluminium hydroxide). Further particularly preferred auxiliary materials include polysiloxanes. Polysiloxanes may in this regard act, for example as flow additives for reducing the viscosity of the polymer melt and/or in particular act as plasticizers in polymer blends.

The content of an auxiliary material in the composition in accordance with the invention may in this regard preferably be at least approximately 0.01% by weight and/or at most approximately 90% by weight, preferably at least 0.01% by weight and/or at most 50% by weight. For auxiliary materials such as stabilizers, UV stabilizers, or colorants, the content is preferably at least 0.01% by weight and/or at most 5% by weight, in particular at least 0.01% by weight and/or at most 2% by weight. For anti-agglomeration agents and IR absorbers, the content is preferably at least 0.01% by weight and/or at most 1% by weight, preferably at least 0.01% by weight and/or at most 0.5% by weight, particularly preferably at least 0.02% by weight and/or at most 0.2% by weight, in particular at least 0.02% by weight and/or at most 0.1% by weight.

Polymer systems often carry a positive and/or negative partial charge. In particular, when particles of the polymer system have different charges at different sites on the surface, this can lead to interactions between adjacent particles, for example by means of electrostatic, magnetic and/or Van-der-Waals forces, resulting in unwanted agglomeration of the polymer system panicles.

In accordance with a further preferred embodiment, an advantageous composition therefore comprises at least one anti-agglomeration agent. The term “anti-agglomeration agent” in this regard is a synonym for the term “anti-caking agent”. The term “anti-agglomeration agent” as used in the present patent application should be understood to mean a material in the form of particles which, inter alia., can be deposited on and/or in the polymer particles.

The term “deposit” in this regard should be understood to mean that particles of the anti-agglomeration agent are attached, for example, by electrostatic forces, chemical bonds (for example ionic and covalent bonds) and hydrogen bonds and/or interact with particles of the polymer or polymer system by means of magnetic forces and/or Van-der-Waals forces and thus come into relative proximity with each other, so that particles of the polymer system advantageously do not come into direct contact with each other, but are separated from each other by particles of the anti-agglomeration agent. The polymer system particles which are separated spatially from each other in this manner in general form weak to practically no interactions with each other, so that the addition of anti-agglomeration agents advantageously counteracts clumping of the composition.

In accordance with a preferred embodiment, therefore, an advantageous composition comprises at least one anti-agglomeration agent. An anti-agglomeration agent of this type may be selected from the group formed by metal soaps, preferably from a silicon dioxide, stearate, tricalcium phosphate, calcium silicate, aluminium oxide, magnesium oxide, magnesium carbonate, zinc oxide or mixtures thereof.

In accordance with a further preferred embodiment, a first anti-agglomeration agent comprises silicon dioxide. This may in this regard be a silicon dioxide produced by a wet chemical precipitation process or a pyrogenic silicon dioxide. Particularly preferably, however, the silicon dioxide is a pyrogenic silicon dioxide.

The term “pyrogenic silicon dioxide” as used in the present patent application should be understood to mean silicon dioxide which is produced in accordance with known processes, for example by flame hydrolysis, by supplying liquid tetrachlorosilane to the hydrogen flame. Silicon dioxide will also be referred to below as silica.

In accordance with a further preferred embodiment, a composition in accordance with the invention has a second anti-agglomeration agent and thus advantageously allows better tailoring of the physical properties, for example as regards the electrostatic, the magnetic and/or the Van-der-Waals forces of the anti-agglomeration agent, on the polymer(s), and thus improves the processability of the composition, in particular in laser sintering processes.

In accordance with a particularly preferred embodiment, the second anti-agglomeration agent is a silicon dioxide, in particular a pyrogenic silicon dioxide.

Clearly, a composition in accordance with the invention may also comprise more than two anti-agglomeration agents.

In an advantageous composition in this regard, a preferred proportion of the at least one anti-agglomeration agent is at most approximately 1% by weight, more preferably at most approximately 0.5% by weight, particularly preferably at most approximately 0.2% by weight, in particular at most approximately 0.15% by weight, particularly preferably at most approximately 0.1% by weight. The proportion in this regard is the proportion of all of the anti-agglomeration agents contained in the advantageous composition.

In principle, the at least one or the two or more anti-agglomeration agents may be treated with one or even with more different hydrophobic aids. In accordance with a further preferred embodiment, the anti-agglomeration agent has a hydrophobic surface. Rendering a material hydrophobic in this manner may, for example, be carried out with a substance based on organosilanes.

Furthermore, the additive can advantageously prevent caking, and thus aggregation of the particles of the polymer system in the composition can be effectively prevented and the formation of voids on pouring can be counteracted, whereupon in addition, the bulk density of the composition is advantageously increased. The bulk density can be influenced by its particle size or particle diameter and particle properties.

The term “bulk density” in this regard describes the ratio of the mass of a granular solid which has been compacted by pouring and not, for example, by ramming or shaking, to the bulk volume it takes up. The determination of the bulk density is known to the person skilled in the art and may, for example, be carried out in accordance with DIN EN ISO 60:2000-01.

A particularly advantageous composition has a bulk density of at least approximately 350 kg/m³ and/or at most approximately 650 kg/m³. The bulk density as used herein refers to the composition in accordance with the invention.

For the additive manufacturing processes discussed above, powders with a relatively round grain shape are required, because the presence of angular particles can mean that striae could occur when applying the powder layers, whereupon in particular, an automatic construction process is made more difficult and the quality of components produced in this manner is compromised, in particular their density and the surface finish quality. However, problems frequently arise with obtaining polymers or copolymers in the form of a powder with round particles.

By means of the composition in accordance with the invention, advantageously, round particles can be obtained. Preferably, round particles of this type which preferably have good pouring properties are produced by means of melt dispersion.

In general, for compositions which are used in laser sintering processes, an appropriate grain size or grain size distribution, a suitable bulk density as well as a sufficient pourability of the powdered material are important.

The term “grain size” describes the size of individual particles or grains in an overall mixture. The grain or particle size distribution has a substantial influence in this regard on the material properties of a bulk material, i.e. of the granular mixture as a whole, which are in a free-flowing form, for example in a powdered composition.

In order to reduce the porosity of the resulting components, polymer systems which are usually employed have small particle sizes or particle diameters. In addition, the polymer systems can be modified during their production, often resulting, however, in agglomeration of the particles. If polymer systems of this type are then tipped into a powder bed of a laser sintering system, then dumping, i.e. a non-homogeneous distribution of particles, may form which do not melt continuously and whereupon a shaped article of a non-homogeneous material is obtained which could have a reduced mechanical stability. Finally, when pouring, dumps which occur can compromise the pourability and thus restrict metering capability. Therefore, anti-agglomeration agents (synonymous with anti-caking agents) are added to such polymer systems and are deposited onto the particles of the polymer system to counteract clumping which could, for example, occur during pouring processes and/or when applied to the powder bed.

In accordance with a further preferred embodiment, the particles of an advantageous composition have a grain size distribution as follows:
d10=at least 10 μm, preferably at least 20 μm and/or at most 50 μm, preferably at most 40 μm
d50=at least 25 μm and/or at most 100 μm, preferably at least 30 μm and/or at most 80 μm, particularly preferably at least 30 μm and/or at most 60 μm
d90=at least 50 μm and/or at most 150 μm, preferably at most 120μm.

Methods for determining the grain size or the grain size distribution are known to the person skilled in the art and can, for example, be carried out using a measuring instrument of the Camsizer XT (Retsch Technology, Germany) type in accordance with DIN ISO 13322-2.

In accordance with a preferred embodiment, an advantageous composition has a distribution width (d90-d10)/d50 of at most 3, preferably at most 2, particularly preferably at most 1.5, in particular at most 1.

A further preferred composition has a proportion of fines, i.e. a proportion of particles with a particle size of less than 10 μm, of less than 10% by weight, preferably less than 6% by weight, in particular less than 4% by weight.

The polymer particles of the composition in accordance with the invention preferably have an essentially spherical to lenticular shape or form. Particularly preferably, the polymer particles of a particularly advantageous composition have a sphericity of at least approximately 0.7, preferably at least approximately 0.8, in particular at least approximately 0.9, particularly preferably at least approximately 0.95. The sphericity can, for example, be determined with the aid of microscopy (in accordance with DIN ISO 13322-1) and/or a measuring instrument of the Camsizer XT (Retsch Technology, Germany) type (in accordance with DIN ISO 13322-2).

It has furthermore been shown to be advantageous for the particles of a composition in accordance with the invention to have as small a surface area as possible. The surface area in this regard can be determined, for example, by gas adsorption in accordance with Brunauer, Emmet and Teller (BET)'s principle; the standard applied is DIN EN ISO 9277.

The particle surface area determined using this method is also known as the BET surface area.

In accordance with a preferred embodiment, the BET surface area of an advantageous composition is at least approximately 0.1 m²/g and/or at most approximately 6 m²/g. Particularly preferably in this regard, an advantageous composition comprises at least one polymer selected from polypropylene. A preferred BET surface area in this case is at least approximately 0.5 m²/g and/or up to approximately 2 m²/g.

The method for the production of the composition in accordance with the invention has already been discussed above. In accordance with a preferred production method, the polymer, which is preferably selected from a polypropylene and/or a polyamide or its copolymers or blends with other polymers, is provided in the form of a granulate which preferably is obtained from a polymer and additive by means of melt compounding in an extruder or a kneader. Particularly preferably, the advantageous composition is produced by means of melt dispersion, in particular using polypropylene and/or polyamide.

Finally, the production of a powder from the granulate can advantageously be carried out by grinding granulate or by fibre spinning and cutting the fibres, or by melt spraying.

Preferably, a polypropylene granulate has a MVR (melt volume flow rate) of at least approximately 2 cm³/10 min and/or at most approximately 70 cm³/10 min; a polyamide granulate preferably has a MVR of at least approximately 10 cm³/10 min and/or at most approximately 40 cm³/10 min. The melt volume flow rate in this regard serves to characterize the flow behaviour of the thermoplastic polymer at a specific temperature and test load. The determination of the MVR is known to the person skilled in the art and can, for example, be carried out in accordance with DIN ISO EN 1133:2011. The measurement for a polypropylene granulate is carried out at a temperature of 230° C. with a test load of 2.16 kg; the measurement for a polyamide granulate is carried out at a temperature of 235° C. with a test load of 2.16 kg. Drying the granulate prior to the MVR determination is carried out in accordance with the manufacturer's instructions. Pre-drying of powder is carried out for 30 minutes at 105° C. under vacuum (100 mbar).

In accordance with a further preferred production method, mixing of the polymer is carried out by dispersion, in particular by means of melt dispersion, wherein the melt dispersion is in the form of a fluid multiphase system comprising the at least one polymer and the preferred additive.

The dispersion step is preferably carried out by melt dispersion in a dispersion device, preferably in an extruder. Alternatively, a melt dispersion may be carried out in a kneader.

Subsequently to the melt extrusion, a further preferred method comprises cooling of the dispersion. Cooling can in this regard be carried out by means of a conveyor belt or a calendar (system of a plurality of temperature-controlled rollers disposed one on top of the other). As an example, the dispersion can in this regard be cooled in a water bath and/or by means of a water/air cooling zone which, for example, may extend over several metres.

Next, the polymer or the polymer particles are separated out of the mixture or the dispersion and the separated polymer or polymer particles are optionally washed and dried.

Separating the components out of the mixture or dispersion is preferably carried out by centrifuging and/or filtration. Drying the solid components in order to obtain the dry composition may in this regard be carried out in an oven, for example in a vacuum dryer.

In a subsequent step, a further agent may be added to the composition in accordance with the invention. In particular, a further agent of this type is selected from an anti-agglomeration agent. Preferably in this regard, the further agent, in particular an anti-agglomeration agent, is added in a mixer.

Finally, an advantageous production process may be provided with packaging of the composition. Packaging of a composition produced using the method in accordance with the invention, in particular of screened polymer particles which preferably are in the form of a powder, is in this regard preferably carried out with the exclusion of moisture from the air, so that subsequent storage of the composition in accordance with the invention can be undertaken with reduced moisture in order, for example, to avoid caking effects, whereupon the stability of the composition in accordance with the invention upon storage is improved. In addition, an advantageous packaging material prevents the ingress of moisture, in particular of moisture from the air, into the composition in accordance with the invention.

As mentioned above, compositions in accordance with the invention are suitable for additive manufacturing processes, in particular for laser sintering processes. Normally, the target environment, for example the powder bed of the irradiation unit, in particular the laser beam, has already been heated prior to using it, so that the temperature of the powdered starting material is close to its melting temperature, and in fact only a small amount of energy input is required in order to raise the overall energy input enough to coalesce the particles or to consolidate them. Further in this regard, energy-absorbing and/or energy-reflecting materials may be applied to the target environment of the irradiation unit as is known, for example, from high speed sintering or multi-jet fusion processes.

The term “melting” in this regard should be understood to mean the process in which during an additive manufacturing process, the powder, for example in the powder bed, is at least partially melted by the input of energy, preferably by means of electromagnetic waves, in particular by means of laser beams. In this manner, at least partial melting of the composition in accordance with the invention and the reliable fabrication of shaped articles with a high mechanical stability and shape accuracy are ensured.

It has furthermore been shown that the tensile strength and elongation at break may be useful as material properties or as a measure of the processability of the composition in accordance with the invention.

In accordance with a further preferred embodiment, an advantageous composition has a tensile strength of at least approximately 5 MPa, preferably at least approximately 25 MPa, in particular at least approximately 50 MPa. The highest tensile strength of the preferred composition is approximately 500 MPa, preferably at most approximately 350 MPa, in particular at most approximately 250 MPa. The values for the elongation at break of the preferred composition in this regard are at least approximately 1%, particularly preferably at least approximately 5%, in particular at least approximately 50%. The highest elongation at break of a preferred composition is at most approximately 1000%, more preferably at most approximately 800%, particularly preferably at most approximately 500%, in particular at most approximately 250%, particularly preferably at most approximately 100%. The determination of the tensile strength and elongation at break may be determined with the aid of what is known as the tensile test in accordance with DIN EN ISO 527 and is known to the person skilled in the art.

Furthermore, the composition in accordance with the invention may be evaluated as regards its metering capability in the cold and warm state in the laser sintering unit, its layer application and powder bed state in the cold and warm state, its layer application in the laser sintering process, preferably in the running laser sintering process, in particular its coating onto exposed surfaces, and the dimensional tolerances and the mechanical properties of the test pieces obtained are evaluated.

Advantageously again, the composition comprises at least one further agent which enables the mechanical, electrical, magnetic, flame retardant and/or aesthetic properties of the powder or product to be tailored. In a preferred embodiment, the composition comprises at least one organic and/or inorganic agent such as, for example, glass, metal, for example aluminium and/or copper or iron, ceramic particles, metal oxides or pigments in order to vary the colour, preferably titanium dioxide or carbon black.

Alternatively or in addition, the further agent may be selected from a fibre such as, for example, a carbon fibre, glass fibre and/or ceramic fibre such as wollastonite, for example. In this manner, the absorption behaviour of the powder can also be influenced. Fillers for tailoring the mechanical properties may also be selected from the group formed by metal oxides, or from calcium carbonate. Flame retardant agents may, for example, be selected from the group comprising metal hydroxides such as magnesium hydroxide or aluminium hydroxide, phosphorus compounds such as red phosphorus or ammonium polyphosphate or bromine-containing flame retardants.

Furthermore, it may be advantageous for the composition to comprise at least one further agent which is used for the thermooxidative stabilization of the polymer and/or for UV stabilization. In this regard, it may, for example, be an antioxidant and/or a UV stabilizer. An antioxidant of this type may, for example, be obtained under the trade name Irganox or Irgafos from BASF (Ludwigshafen, Germany); a UV stabilizer may, for example, be obtained from BASF under the trade name Tinuvin.

Furthermore, it may be advantageous for an IR absorber to be used as the further agent, which absorbs in the wavelength range of the laser or the infrared heating used. In this regard, this may be carbon black and/or copper hydroxide phosphate, for example.

In addition to functionalization by adding pigments, for example, in principle, compounds with specific functional properties may be present in one or more of the layers or in the entire shaped article. A functionalization may, for example, consist of making the entire shaped article, one or more layers of the shaped article or even only parts of one or more layers of the shaped article electrically conductive. This functionalization may be obtained by means of conductive pigments such as metal powder, for example, or by using conductive polymers such as, for example, by adding polyaniline. In this manner, shaped articles which have strip conductors are obtained, wherein they may be both on the surface and also within the shaped article.

Further features of the invention will become apparent from the description below of exemplary embodiments made in connection with the claims. It should be noted that the invention is not limited to the embodiments of the exemplary embodiments described, but is defined by the scope of the accompanying claims. In particular, the individual features of embodiments in accordance with the invention may be combined in combinations other than as described in the examples set out below. The discussion below of some exemplary embodiments of the invention is made with reference to the accompanying figure, in which:

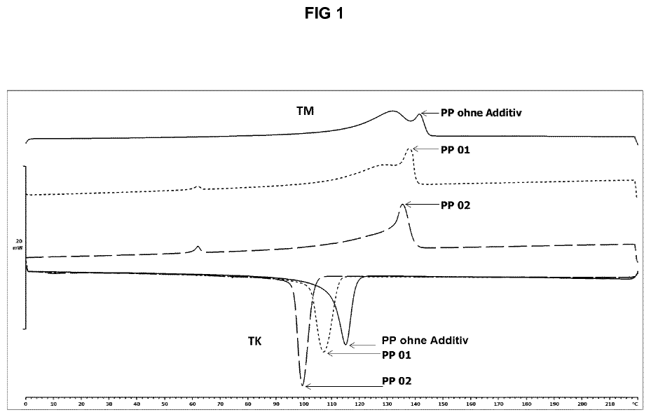

FIG. 1 shows a DSC thermogram of compositions in accordance with the invention (“PP 001”, “PP002”) compared with a composition which does not contain any additive (“PP without additive”).

### EXAMPLES

### Example 1

Polypropylene (PP) (polypropylene-polyethylene copolymer, Borealis, Austria) with a MVR of 30 cm³/10 min was mixed together with polyethylene glycol (PEG; molecular weight (MW) 20000 D and 35000 D; Clariant, Switzerland) in a ratio of 30% by weight of PP copolymer to 70% by weight of polyethylene glycol in an extruder (ZSE 27 MAXX, Leistritz Extrusionstechnik GmbH, Nuremburg, Germany) in the molten state (zone temperature: from 220 to 360° C.). For the “PP 01” sample, the ratio of polyethylene glycol 20000 to 35000 was 50% by weight to 50% by weight. For the sample “PP 02”, the ratio of polyethylene glycol 20000 to 35000 was 80% by weight to 20% by weight. After extrusion, the mixture was cooled on a conveyor belt to room temperature, in ambient air, and packaged. In order to dissolve the polyethylene glycol, the mixture was then dissolved in water, with stirring (1 kg of the mixture in 9 kg of water) and centrifuged (TZ3 centrifuge, Carl Padberg Zentrifugenbau GmbH, Lahr, Germany). The powder cake formed by the PP copolymer was washed twice with 10 litres of water in the centrifuge in order to remove the surplus polyethylene glycol. The powder cake was then dried at 60° C. under 300 mbar for 10 hours in a vacuum dryer (Heraeus, VT6130 P, Thermo Fisher Scientific, Germany). Next, the powder was screened with the aid of a tumbler screening machine (screen mesh size: 245 μm, Siebtechnik GmbH, Mühlheim, Germany). In a container mixer (Mixaco Labor Container Mixer, 12 litres, Mixaco Maschinenbau Dr. Herfeld GmbH & Co KG, Neuenrade, Germany) the powder was supplemented with 0.1% by weight of an anti-agglomeration agent (Aerosil R974, Evonik Resource Efficiency, Hanau, Germany), stirring for 1 minute. Powders with the following grain size were obtained:

Sample “PP 01”: d50=45 μm

Sample “PP 02”: d50=40 μm

The polyethylene glycol content in the dry compositions (“PP 01”, “PP 02”) was determined by means of DSC (DIN EN ISO 11357) on a DSC measuring instrument (Mettler Toledo DSC823). The evaluation was carried out with the aid of STARe 15.0 software. The method and/or data for the evaluation are shown in Table 1. The polyethylene glycol content in the dry compositions is recorded in Table 2 (below). The polyethylene oxide (PEO) content can also be determined in the same manner when this is used as the additive during production.

TABLE 1
Detailed description of the DSC method for the compositions in accordance with
the invention as well as the integration limit and ΔH_{m PEG} of PEG/PEO for the
determination of the PEG/PEO content in the sample.

| | | Start | End | Heating/cooling | PEG/PEO | |
|---|---|---|---|---|---|---|
| Method | Operation | temperature | temperature | rate [K/min] or | integration limit | ΔH_{m PEG} |
| segment | type | [° C.] | [° C.] | hold time [min] | [° C.] | [J/g] |
| 1 | isothermal | 0 | 0 | 3 min | n.d. | n.d. |
| 2 | dynamic | 0 | 220 | 10K/min | n.d. | n.d. |
| 3 | isothermal | 220 | 220 | 3 min | n.d. | n.d. |
| 4 | dynamic | 220 | 0 | −10K/min | n.d. | n.d. |
| 5 | isothermal | 0 | 0 | 3 min | n.d. | n.d. |
| 6 | dynamic | 0 | 220 | 10K/min | from 55 to 70 | 171 |

n.d. = not determined

Methods for calculating the content of additive in the composition in accordance with the invention:

1) Method 1: For PEG/PEO in polypropylene:

Table 1 records the DSC method as well as the integration limits and melting enthalpy of a PEG sample (ΔH_{m PEG}). In addition, the content of polyethylene oxide (PEO), when this is used as the additive during production, can be determined in the same manner.

The PEG/PEO melting enthalpy is determined in the 2nd heating cycle (segment 6 of the DSC method). Based on these values and with the aid of formula 1, the PEG/PEO content in the sample is determined as follows:

$$PEG content [ \% ] = \frac{Δ {H}_{PEG}}{Δ {H}_{m PEG}} * 100 \qquad formula 1$$

ΔH_{PEG} is the PEG melting enthalpy in the sample, determined using the method shown in Table 1.

ΔH_{m PEG} is the PEG melting enthalpy of a pure PEG sample (171 J/g), determined using polyglycol 20000 S (technical quality, Clariant, Switzerland).

2) Method 2: For PEG/PEO in semicrystalline and amorphous polymers and polymer blends:

Analogous to the determination of the content of PEG/PEO in polypropylene (see method 1). In contrast to method 1, though, 220° C. was used for the start temperature (segments 3+4) and the end temperature (segments 2+3+6) in the DSC; the temperature employed was that used for the semicrystalline polymer, in accordance with DIN EN ISO 11357. However, the maximum end temperature was limited to 360° C. in order to avoid thermal degradation of the PEG/PEO.

3) Method 3: For semicrystalline additives by means of DSC:

Analogous to the determination of the PEG/PEO content in semicrystalline polymers (see method 2). The difference was for the start temperature (segments 3+4) and end temperature (segments 2+3+6) in the DSC; the temperature employed was that used for the semicrystalline polymer or the additive, in accordance with DIN EN ISO 11357. Whichever was the higher temperature, this was the one employed.

The determination of the additive content was made analogously to the determination of the PEG/PEO content. However, in contrast, DSC method 3 was employed.

$$Additive content [ \% ] = \frac{Δ {H}_{additive}}{Δ {H}_{m additive}} * 100 \qquad formula 2$$

ΔH_{Additive} is the melting enthalpy of the additive in the sample, determined using the DSC method 3.

ΔH_{m Additive} is the melting enthalpy of the pure additive, determined using the DSC method 3.

The crystallization and melting temperatures of the compositions were determined by means of DSC (DIN EN ISO 11357) on a DSC measuring instrument (Mettler Toledo DSC823). The evaluation was carried out with the aid of STARe 15.0 software. The changes to the crystallization and melting temperatures of the composition in accordance with the invention with additive (“PP 01”, “PP 02”) compared to a composition without the addition of an additive (“PP without additive”) are shown in Table 2 and FIG. 1.

FIG. 1 is a DSC thermogram of the “PP without additive”, “PP 01” and “PP 02” samples which are conventionally plotted as a function of temperature (° C.). Instead of the ordinate, a reference bar of 20 mW is provided. In the upper three curves are the respective melting peaks, i.e. the temperature TM at which the composition melts for the samples “PP without additive”, “PP 01” and “PP 02”. The lower curves show the crystallization temperatures TK of the samples “PP without additive”, “PP 01” and “PP 02”.

Upon the addition of additive, a variation in both the crystallization temperature, TK, and also in the melting temperature, TM, was observed. The comparative sample “PP without additive” had a crystallization temperature of approximately 115° C. (see Table 2: “PP without additive” sample, column “TK 1st heating rate (HR)”; FIG. 1: solid line, uppermost DSC thermogram). With a content of additive of 0.64% by weight in the dry composition in accordance with the invention (“PP 01”) in the present case of PEG with a molecular weight (MW) of 35000 D and 20000 D in a ratio of 50:50, there was a reduction in the crystallization temperature of approximately 8° C., namely from approximately 115° C. to approximately 107° C. (see Table 2: sample (“PP 01”), column “TK 1st HR”; FIG. 1: dotted line, second to top DSC thermogram). At a PEG content of 1.09% by weight in the dry composition in accordance with the invention (“PP 02”) (PEG MW 35000 D to MW 20000 D: ratio: 20:80), a reduction in the crystallization temperature of approximately 15° C., from approximately 115° C. to approximately 100° C., was produced (see Table 2: sample “PP 02”, column “TK 1st HR”; FIG. 1: dashed line, third DSC thermogram from top).

In respect of a variation in the melting temperature TM of the composition in accordance with the invention in comparison with a sample without additive, it should be noted that for the sample without additive, a “double peak” at approximately 132° C. and 141° C. was observed (see Table 2: “sample without additive”, column “TM 2nd HR”; FIG. 1: lowest solid line). With an additive content of 0.64% by weight, however, one melting peak could be observed which had a peak at approximately 137.5° C. (see Table 2: sample “PP 01”, column “TM 2nd HR”; FIG. 1: lowest dotted line); finally, for the sample “PP 02” which had an additive content of 1.09% by weight, there was a peak at approximately 135° C. (see Table 2: sample “PP 02”, column “TM 2nd HR”; FIG. 1: lowest dashed line).

TABLE 2
Crystallization and melting temperatures of polypropylene copolymer samples
(PP) without the addition of additive (“PP without additive”) and with the addition of
additive (“PP 01”, “PP 02”). The additive consisted of a mixture of PEG with a molecular
weight (MW) of 35000 D and 20000 D in the ratios shown.

| | Additive/ | | | TM | | | | | |
|---|---|---|---|---|---|---|---|---|---|
| | s | | | onset/ | | | | TK | |
| | PEG | Additive(s) | | TM | | | | onset/TK | |
| | 35000 | content in dry | TM | endset | XC | dH | TK | endset | XC |
| | D/PEG | composition | 2nd HR | 2nd HR | 2nd HR | 2nd HR | 1st HR | 1st HR | 1st HR |
| Polymer | 20000 D | [% by wt] | [° C.] | [° C.] | [%] | [J/g] | [° C.] | [° C.] | [%] |
| PP | n.a. | n.d. | 131.75/ | 74.94/ | 39.33 | 82.20 | 115.36 | 118.76/ | 39.45 |
| without | | | 140.8 | 144.52 | | | | 109.77 | |
| additive | | | | | | | | | |
| PP 01 | 50/50 | 0.64 | Shoulder/ | 131.73/ | 37.96 | 79.34 | 107.51 | 112.62/ | 39.48 |
| | | | 137.47 | 139.97 | | | | 102.32 | |
| PP 02 | 20/80 | 1.09 | 135.04 | 130.67/ | 36.55 | 76.39 | 100.00 | 103.66/ | 37.93 |
| | | | | 139.46 | | | | 96.41 | |

n.a. = not applicable
TM = melting temperature
TK = crystallization temperature
HR = heating rate
XC = crystallinity
dH = melting enthalpy

### Example 2

The production of the composition in accordance with the invention of Example 2 was carried out in the same manner as for Example 1. The polypropylene-polyethylene copolymer used (type QR674K) in Example 2 was obtained from Sabic Innovative Plastics (Bergen op Zoom, Netherlands); the additive used was polyethylene glycol (Clariant, Switzerland) with a molar mass of 35000 D. A powder with the following grain size was obtained:

PP 03: d50=29 μm

The determination of the content of PEG was carried out in analogous manner to Example 1.

The melting temperature TM and crystallization temperature TK of the composition in accordance with the invention “PP 03” compared with a “PP without additive” sample is shown in Table 3. Again, with the addition of additive, a variation in the crystallization temperature TK and also in the melting temperature TM compared with a sample without additive was observed. The “PP without additive” comparative sample had a crystallization temperature of approximately 120° C. (see Table 3: sample “PP without additive”, column “TK 1st heating rate (HR)”). With an additive content of 0.08% by weight in the dry composition in accordance with the invention (“PP 03”), in the present case of PEG with a molecular weight (MW) of 35000 D, there was a reduction in the crystallization temperature of approximately 12° C., namely from approximately 120° C. to approximately 108° C. (see Table 3: sample “PP 03”, column “TK 1st HR”).

TABLE 3
Crystallization and melting temperature of polypropylene copolymer samples
(PP) without the addition of additive (“PP without additive”) and with the addition of
additive (“PP 03”). The additive consisted of PEG with a molecular weight (MW) of 35000
D.

| | | | | | | | TK | |
|---|---|---|---|---|---|---|---|---|
| | PEG content | | TM onset/ | | | | onset/TK | |
| | in dry | TM | TM endset | XC | dH | TK | endset | XC |
| | composition | 2nd HR | 2nd HR | 2nd HR | 2nd HR | 1st HR | 1st HR | 1st HR |
| Polymer | [% by wt] | [° C.] | [° C.] | [%] | [J/g] | [° C.] | [° C.] | [%] |
| PP without | n.d. | 135.5/148.9 | 139.3/ | 38.8 | 81.1 | 119.8 | 123.3/ | 39.1 |
| additive | | | 153.1 | | | | 113.8 | |
| PP 03 | 0.08% | 144.2 | 137.0/ | 37.0 | 77.4 | 108.1 | 110.1/ | 38.3 |
| | | | 150.6 | | | | 104.9 | |

### Example 3

Polyether ketone ketone (PEKK) (Kepstan 6004, Arkema, France) was mixed together with polyethylene glycol (PEG; molecular weight (MW) 20000 D and 35000 D; Clariant, Switzerland) or polyethylene oxide (PEO: molecular weight (MW) 100000 D; The Dow Chemical Company, Polyox WSR N10) in a ratio of 30-40% by weight of PEKK to 60-70% by weight of PEG and/or PEO, in an extruder (ZSE 27 MAXX, Leistritz Extrusionstechnik GmbH, Nuremburg, Germany) in the molten state (zone temperature: 340° C.). The exact ratios are shown in Table 4. After extrusion, the mixture was cooled on a conveyor belt at a cooling rate of 5° C./second (s) to room temperature and packaged. In order to dissolve the PEG or PEO, a portion of the mixture was then dissolved at 70° C. in water, with stirring (30 g in 150 mL of water), screened in a vibration screening machine (AS200, mesh size 300 μm, Retsch, Haan, Germany) and the <300 μm filtrate was filtered off using a Büchner funnel. The powder cake was washed twice more with 150 mL of water in an Erlenmeyer flask and filtered each time in a Büchner funnel in order to remove the surplus PEG or PEO. The powder cake was then dried at 60° C. under 300 mbar for 10 hours in a vacuum dryer (Heraeus, VT6130 P, Thermo Fisher Scientific, Germany). Powder samples were obtained with the properties shown in Table 5. The determination of the grain size distribution and sphericity (SPHT3) was carried out using a Camsizer XT (Retsch Technology, Software Version 6.0.3.1008, Germany) in accordance with DIN ISO 13322-2, with the X-Flow module in a solution of Triton X in distilled water (3 percent by weight). Evaluation on the basis of Xarea.

TABLE 4
Proportions of PEKK and PEG 20000 or PEG
35000 and PEO in the test compositions.

| | | PEG | PEG | |
|---|---|---|---|---|
| | PEKK | 20000 D | 35000 D | PEO |
| | [% by wt] | [% by wt] | [% by wt] | [% by wt] |
| PEKK | 100 | n.a. | n.a. | n.a. |
| without | | | | |
| additive | | | | |
| PEKK-01 | 30 | 0 | 0 | 70 |
| PEKK-02 | 30 | 0 | 17.5 | 52.5 |
| PEKK-03 | 30 | 0 | 35 | 35 |
| PEKK-04 | 30 | 0 | 70 | 0 |
| PEKK-05 | 30 | 17.5 | 52.5 | 0 |
| PEKK-06 | 40 | 0 | 60 | 0 |
| PEKK-07 | 30 | 35 | 35 | 0 |
| PEKK-08 | 30 | 70 | 0 | 0 |

n.a. = not applicable

TABLE 5
Grain size distribution and DSC measurements of the tested (dry) compositions.

| | | | | DSC | | | | | | |
|---|---|---|---|---|---|---|---|---|---|---|
| | | | | | | | | | | PEG/PEO |
| | | | | TM | XM | TM | XM | TM | XM | content in |
| | Grain size distribution | | | 1st | 1st | 2nd | 2nd | 1st | 1st | dry |
| | d10 | d50 | d90 | HR | HR | HR | HR | HR | HR | composition |
| | [μm] | [μm] | [μm] | [° C.] | [%] | [° C.] | [%] | [° C.] | [%] | [% by wt] |
| PEKK | n.d. | n.d. | n.d. | 291.1 | 0.0 | 301.3 | 23.6 | 241.3 | 22.0 | n.d. |
| without | | | | | | | | | | |
| additive | | | | | | | | | | |
| PEKK-01 | 4.9 | 9.5 | 27.7 | 284.6 | 14.4 | 300.0 | 24.1 | 236.6 | 23.6 | 0.019 |
| PEKK-02 | 9.8 | 11.7 | 28.8 | 284.9 | 14.6 | 297.9 | 24.6 | 237.0 | 22.9 | 0.035 |
| PEKK-03 | 14.6 | 24.2 | 80.3 | 283.7 | 16.0 | 297.1 | 26.0 | 238.7 | 25.7 | 0.022 |
| PEKK-05 | 12.1 | 31.6 | 79.2 | 284.0 | 18.6 | 298.4 | 28.3 | 242.1 | 26.6 | 0.141 |
| PEKK-06 | 14.9 | 40.8 | 95.9 | 284.1 | 19.2 | 299.1 | 28.8 | 242.7 | 29.9 | 0.153 |
| PEKK-07 | 18.5 | 41.3 | 82.8 | 284.3 | 17.8 | 298.8 | 22.8 | 244.2 | 31.7 | 0.106 |
| PEKK-08 | 22.5 | 62.7 | 135.7 | 284.7 | 16.6 | 297.9 | 27.2 | 242.3 | 26.4 | 0.141 |
| PEKK-09 | 24.0 | 76.7 | 181.6 | 284.2 | 14.9 | 297.6 | 28.5 | 242.7 | 28.4 | 0.110 |

The PEG or PEO content of the dry compositions was determined by means of DSC (DIN EN ISO 11357) on a DSC measuring instrument (Mettler Toledo DSC823). The evaluation was carried out with the aid of STARe 15.0 software. The method and/or data for the evaluation are shown in Table 6. Because PEKK, as a quasi-amorphous polymer, does not crystallize at 10° C./min or 20° C./min, in order to initiate crystallization, the measurement was carried out in segment 5 at a cooling rate of 2° C./min—this was not in accordance with the standard.

TABLE 6
Detailed description of the DSC method for the compositions in accordance with
the invention as well as the integration limit and ΔH_{m PEG} of PEG/PEO for the
determination of the PEG/PEO content in the PEKK samples.

| | | | | | PEG/PEO | |
|---|---|---|---|---|---|---|
| | | Start | End | Heating/cooling | integration | |
| Method | Operation | temperature | temperature | rate [K/min] or | limit | ΔH_{m PEG} |
| segment | type | [° C.] | [° C.] | hold time [min] | [° C.] | [J/g] |
| 1 | isothermal | 0 | 0 | 3 min | n.d. | n.d. |
| 2 | dynamic | 0 | 360 | 20K/min | n.d. | n.d. |
| 3 | isothermal | 360 | 360 | 3 min | n.d. | n.d. |
| 4 | dynamic | 360 | 280 | −20K/min | n.d. | n.d. |
| 5 | dynamic | 280 | 180 | −2K/min | n.d. | n.d. |
| 6 | dynamic | 180 | 0 | −20K/min | n.d. | n.d. |
| 7 | isothermal | 0 | 0 | 3 min | n.d. | n.d. |
| 8 | dynamic | 0 | 360 | 20K/min | from 55 to 70 | 171 |

The method for calculating the additive content of the composition in accordance with the invention was carried out in accordance with the description of Example 1. In contrast to this, the PEG/PEO melting enthalpy was determined in segment 8 instead of segment 6 of the DSC method.

It can be seen from Table 5 that the grain size can be adjusted as a function of the molar mass of PEG and PEO. With increasing molar mass (PEO fraction), the crystallization point of the material can also be reduced. This method also shows a further major advantage of PEKK. Unfilled PEKK (60:40 T/L of copolymer) (PEKK without additive), which was extruded without PEG/PEO, is present as a quasi-amorphous granulate, because cooling after extrusion occurs very rapidly (typically >100° C./s). The DSC revealed cold post-crystallization with an exothermic peak at approximately 256° C. with a subsequent endothermic peak at 306° C., TM 1st HR. A common integration of the post-crystallization peak and subsequent melting peak produced a melting enthalpy of 0 J/g and thus a crystallinity of 0%, XC 1st HR, in the granulate. However, amorphous materials are rather difficult to process with laser sintering. By means of melt emulsification, a semicrystalline PEKK powder was obtained with a melting point TM (1st HR) of approximately 284° C. and a crystallinity XM (1st HR) of 14.4-19.2%. The calculation of the value for the crystallinity by means of DSC in this regard produced 130 J/g for theoretically 100% crystalline PEKK (source: Cytec, Technical Data Sheet, PEKK Thermoplastic Polymer, Table 3). For all of the powders, with the exception of PEKK-03, sphericities of >0.9 (Camsizer XT, SPHT3) were obtained.

### Example 4

A carbon fibre-filled PEKK (PEKK-CF, HT23, Advanced Laser Materials, Temple TX, USA) was mixed together with polyethylene glycol (PEG; molecular weight (MW) 20000 D and 35000 D; Clariant, Switzerland) or polyethylene oxide (PEO: molecular weight (MW) 100000 D; The Dow Chemical Company, Polyox WSR N10) at a ratio of 30% by weight of PEKK to 70% by weight of PEG and/or PEO, in an extruder (ZSE 27 MAXX, Leistritz Extrusionstechnik GmbH, Nuremburg, Germany) in the molten state (zone temperature: 340° C.). The exact ratios are provided in Table 7. After extrusion, the mixture was cooled on a conveyor belt at a cooling rate of 5° C./second (s) to room temperature and packaged. In order to dissolve the PEG or PEO, a portion of the mixture was then dissolved at 70° C. in water, with stirring (30 g in 150 mL of water), screened in a vibration screening machine (AS200, mesh size 300 μm, Retsch, Haan, Germany) and the <300 μm filtrate was filtered off using a Büchner funnel. Subsequently, the powder cake was washed twice with 150 mL of water in an Erlenmeyer flask and filtered each time in a Büchner funnel in order to remove the surplus PEG or PEO. The powder cake was then dried at 60° C. under 300 mbar for 10 hours in a vacuum dryer (Heraeus, VT6130 P, Thermo Fisher Scientific, Germany). Powder was obtained with the properties shown in Table 8. The determination of the grain size distribution and sphericity (SPHT3) was carried out using a Camsizer XT (Retsch Technology, Software Version 6.0.3.1008, Germany) in accordance with DIN ISO 13322-2, with the X-Flow module in a solution of Triton X in distilled water (3 percent by weight). Evaluation on the basis of Xarea.

TABLE 7
PEKK-CF and PEG 20000 or PEG 35000 and PEO
proportions of the tested compositions.

| | | PEG | PEG | |
|---|---|---|---|---|
| | PEKK | 20000 D | 35000 D | PEO |
| | [% by wt] | [% by wt] | [% by wt] | [% by wt] |
| PEKK-CF | 100 | n.a. | n.a. | n.a. |
| without | | | | |
| additive | | | | |
| PEKK-CF-01 | 30 | 0 | 0 | 70 |
| PEKK-CF-02 | 30 | 0 | 17.5 | 52.5 |
| PEKK-CF-04 | 30 | 0 | 52.5 | 17.5 |
| PEKK-CF-05 | 30 | 0 | 70 | 0 |
| PEKK-CF-06 | 30 | 35 | 35 | 0 |

TABLE 8
Grain size distribution and DSC measurements of the tested (dry) compositions.

| | | | | DSC | | | | | | |
|---|---|---|---|---|---|---|---|---|---|---|
| | Grain size | | | TM | XM | TM | XM | TK | XC | PEG/PEO |
| | distribution | | | 1st | 1st | 2nd | 2nd | 1st | 1st | content in dry |
| | d10 | d50 | d90 | HR | HR | HR | HR | HR | HR | composition |
| | [μm] | [μm] | [μm] | [° C.] | PA | [° C.] | PA | [° C.] | PA | [% by wt] |
| PEKK-CF | n.d. | n.d. | n.d. | n.d.- | n.d.- | 298.9 | 20.6 | 262.0 | 26.1 | n.d. |
| without | | | | | | | | | | |
| additive | | | | | | | | | | |
| PEKK-CF-01 | 4.8 | 16.0 | 99.6 | 283.9 | 16.5 | 296.5 | 19.6 | 246.8 | 24.8 | 0.043 |
| PEKK-CF-02 | 5.8 | 15.7 | 104.1 | 284.6 | 16.5 | 297.2 | 20.5 | 244.4 | 25.3 | 0.031 |
| PEKK-CF-04 | 18.5 | 47.2 | 141.8 | 283.8 | 12.5 | 296.9 | 21.5 | 247.8 | 29.8 | 0.057 |
| PEKK-CF-05 | 8.5 | 45.2 | 155.2 | 283.7 | 15.7 | 297.3 | 21.8 | 247.9 | 27.1 | 0.011 |
| PEKK-CF-06 | 26.0 | 122.5 | 261.8 | 284.4 | 16.7 | 297.2 | 20.9 | 252.5 | 27.0 | 0.068 |

The PEG or PEO content in the dry compositions was determined by means of DSC (DIN EN ISO 11357) on a DSC measuring instrument (Mettler Toledo DSC823). The evaluation was carried out with the aid of STARe 15.0 software. The method and/or data for the evaluation are shown in Table 9. The PEG or PEO content in the dry compositions is recorded in Table 8.

TABLE 9
Detailed description of the DSC method for the compositions in accordance with
the invention as well as the integration limit and ΔH_{m PEG} of PEG/PEO for the
determination of the PEG/PEO content in the carbon fibre-filled PEKK
samples (PEKK-CF).

| | | | | | PEG/PEO | |
|---|---|---|---|---|---|---|
| | | Start | End | Heating/cooling | integration | |
| Method | Operation | temperature | temperature | rate [K/min] or | limit | ΔH_{m PEG} |
| segment | type | [° C.] | [° C.] | hold time [min] | [° C.] | [J/g] |
| 1 | isothermal | 0 | 0 | 3 min | n.d. | n.d. |
| 2 | dynamic | 0 | 360 | 20K/min | n.d. | n.d. |
| 3 | isothermal | 360 | 360 | 3 min | n.d. | n.d. |
| 4 | dynamic | 360 | 280 | −20K/min | n.d. | n.d. |
| 5 | dynamic | 280 | 180 | −2K/min | n.d. | n.d. |
| 6 | dynamic | 180 | 0 | −20K/min | n.d. | n.d. |
| 7 | isothermal | 0 | 0 | 3 min | n.d. | n.d. |
| 8 | dynamic | 0 | 360 | 20K/min | from 55 to 70 | 171 |

The method for calculating the additive content in the composition in accordance with the invention was carried out in accordance with the description of Example 1. However, the PEG/PEO melting enthalpy was determined in segment 8 instead of in segment 6 of the DSC method.

Table 8 clearly shows that the grain size can be adjusted as a function of the molar mass of PEG and PEO. With increasing molar mass (PEO fraction), the crystallization point of the material can also be reduced. The method also shows a further major advantage for filled PEKK-CF, analogously to unfilled PEKK. Even PEKK-CF without additive, which is extruded without PEG/PEO, is present as a quasi-amorphous granulate, because cooling after extrusion was carried out very rapidly (DSC revealed a cold post-crystallization with an exothermic peak at approximately 255° C. with a subsequent endothermic peak at 306° C., TM 1^{st} HR. A common integration of post-crystallization peak and subsequent melting peak produced a melting enthalpy of 0 J/g and thus a crystallinity of 0%, XC 1st HR, in the granulate). However, amorphous materials are rather difficult to process by laser sintering. By means of melt emulsification, semicrystalline PEKK-CF powder was obtained with a melting point TM (1st HR) of approximately 284° C. and a crystallinity XM (1st HR) of 14.4-19.2%. The calculation of the value for the crystallinity by means of DSC was carried out in this regard with 130 J/g for theoretically 100% crystalline PEKK (source: Cytec, Technical Data Sheet, PEKK Thermoplastic Polymer, Table 3), not including the carbon fibre fraction of 23%.

### Example 5

Polyetherimide (PEI) (Ultem 1010, Sabic Innovative Plastics, Bergen op Zoom, Netherlands) was mixed together with polyethylene glycol (PEG; molecular weight (MW) 35000 D; Clariant, Switzerland) or polyethylene oxide (PEO: molecular weight (MW) 100000 D; The Dow Chemical Company, Polyox WSR N10) in a ratio of 30% by weight of PEI to 70% by weight of PEG and/or PEO, in an extruder (ZSE 27 MAXX, Leistritz Extrusionstechnik GmbH, Nuremburg, Germany) in the molten state (zone temperature: 340° C.). The exact ratios are provided in Table 9. After extrusion, the mixture was cooled on a conveyor belt at a cooling rate of 5° C./second (s) to room temperature and packaged. In order to dissolve the PEG or PEO, a portion of the mixture was then dissolved at 70° C. in water, with stirring (10 g in 1500 mL of water), screened in a vibration screening machine (AS200, mesh size 300 μm, Retsch, Haan, Germany) and the <300 μm filtrate was filtered off using a Büchner funnel. The powder cake was washed twice more with 1500 mL of water in an Erlenmeyer flask and filtered each time in a Büchner funnel in order to remove the surplus PEG or PEO. The powder cake was then dried at 60° C. under 300 mbar for 10 hours in a vacuum dryer (Heraeus, VT6130 P, Thermo Fisher Scientific, Germany). Powder was obtained with the properties shown in Table 10. The determination of the grain size distribution and sphericity (SPHT3) was carried out using a Camsizer XT (Retsch Technology, Software Version 6.0.3.1008, Germany) in accordance with DIN ISO 13322-2, with the X-Flow module in a solution of Triton X in distilled water (3 percent by weight). Evaluation on the basis of Xarea.

TABLE 10
PEI and PEG 20000 or PEG 35000 and PEO fractions of the tested
compositions as well as data regarding the grain size distribution and
DSC of the dry compositions.

| | | | | | | | | DSC |
|---|---|---|---|---|---|---|---|---|
| | | | | | | | | PEG/PEO |
| | | PEG | PEG | | Grain size distribution | | | content in dry |
| | PEI | 20000 D | 35000 D | PEO | d10 | d50 | d90 | composition |
| | [% by wt] | [% by wt] | [% by wt] | [% by wt] | [μm] | [μm] | [μm] | [% by wt] |
| PEI | 100 | n.a. | n.a. | n.a. | n.d. | n.d. | n.d. | n.d. |
| without | | | | | | | | |
| additive | | | | | | | | |
| PEI-01 | 30 | 0 | 0 | 70 | 6.8 | 14.9 | 88.5 | 0.082 |
| PEI-02 | 30 | 0 | 17.5 | 52.5 | 10.4 | 20.3 | 71.0 | 0.030 |
| PEI-03 | 30 | 0 | 25.9 | 44.1 | 24.5 | 56.9 | 89.3 | 0.061 |
| PEI-04 | 30 | 0 | 35 | 35 | 42.1 | 97.0 | 168.0 | 0.009 |
| PEI-05 | 30 | 0 | 70 | 0 | 31.1 | 128.4 | 230.1 | 0.044 |

The PEG or PEO content in the dry compositions was determined by means of DSC (DIN EN ISO 11357) on a DSC measuring instrument (Mettler Toledo DSC823). The evaluation was carried out with the aid of STARe 15.0 software. The method and/or data for the evaluation are shown in Table 11. The PEG or PEO content in the dry compositions is recorded in Table 10.

TABLE 11
Detailed description of the DSC method for the compositions in accordance
with the invention as well as the integration limit and ΔH_{m PEG} of PEG/PEO
for the determination of the PEG/PEO content in the PEI samples.

| | | | | | PEG/PEO | |
|---|---|---|---|---|---|---|
| | | Start | End | Heating/cooling | integration | |
| Method | Operation | temperature | temperature | rate [K/min] or | limit | ΔH_{m PEG} |
| segment | type | [° C.] | [° C.] | hold time [min] | [° C.] | [J/g] |
| 1 | isothermal | 0 | 0 | 3 min | n.d. | n.d. |
| 2 | dynamic | 0 | 360 | 20K/min | n.d. | n.d. |
| 3 | isothermal | 360 | 360 | 3 min | n.d. | n.d. |
| 4 | dynamic | 360 | 0 | −20K/min | n.d. | n.d. |
| 5 | isothermal | 0 | 0 | 3 min | n.d. | n.d. |
| 6 | dynamic | 0 | 360 | 20K/min | from 55 to 70 | 171 |

The method for calculating the additive content in the composition in accordance with the invention was carried out in accordance with the description in Example 1, in segment 6 of the DSC method.

Table 10 clearly shows that the grain size can be adjusted as a function of the molar mass of PEG and PEO. Because PEI is melt amorphous, no melting point and no crystallization point could be determined.

### Example 6

Linear polyphenylene sulphide (PPS) (MVR (315° C., 2.16 kg)=33 cm³/10 min) was mixed together with polyethylene glycol (PEG; molecular weight (MW) 20000 D and/or 35000 D; Clariant, Switzerland) or polyethylene oxide (PEO: molecular weight (MW) 100000 D; The Dow Chemical Company, Polyox WSR N10) in a ratio of 30-40% by weight of PPS to 60-70% by weight of PEG and/or PEO, in an extruder (ZSE 27 MAXX, Leistritz Extrusionstechnik GmbH, Nuremburg, Germany) in the molten state (zone temperature: 290° C.). The exact ratios are provided in Table 12. After extrusion, the mixture was cooled on a conveyor belt at a cooling rate of 4° C./second (s) to room temperature and packaged. In order to dissolve the PEG or PEO, a portion of the mixture was then dissolved at 70° C. in water, with stirring (30 g in 150 mL of water), screened in a vibration screening machine (AS200, mesh size 300 μm, Retsch, Haan, Germany) and the <300 μm filtrate was filtered off using a Büchner funnel. Subsequently, the powder cake was washed twice with 150 mL of water in an Erlenmeyer flask, filtered each time in the Büchner funnel, in order to remove the surplus PEG or PEO. The powder cake was then dried at 60° C. under 300 mbar for 10 hours in a vacuum dryer (Heraeus, VT6130 P, Thermo Fisher Scientific, Germany). Powder was obtained with the properties shown in Table 13. The determination of the grain size distribution and sphericity (SPHT3) was carried out using a Camsizer XT (Retsch Technology, Software Version 6.0.3.1008, Germany) in accordance with DIN ISO 13322-2, with the X-Flow module in a solution of Triton X in distilled water (3 percent by weight). Evaluation on the basis of Xarea.

TABLE 12
PPS and PEG 20000 or PEG 35000 and PEO
proportions in the tested compositions.

| | | PEG | PEG | |
|---|---|---|---|---|
| | PPS | 20000 D | 35000 D | PEO |
| | [% by wt] | [% by wt] | [% by wt] | [% by wt] |
| PPS | 100 | n.a. | n.a. | n.a. |
| without | | | | |
| additive | | | | |
| PPS-01 | 30 | 0 | 0 | 70 |
| PPS-02 | 30 | 0 | 35 | 35 |
| PPS-03 | 30 | 0 | 70 | 0 |
| PPS-04 | 30 | 35 | 35 | 0 |
| PPS-05 | 40 | 30 | 30 | 0 |
| PPS-06 | 30 | 70 | 0 | 0 |

TABLE 13
Grain size distribution and DSC measurements of the tested (dry)
compositions.

| | | | | DSC | | | | | | |
|---|---|---|---|---|---|---|---|---|---|---|
| | Grain size | | | TM | XM | TM | XM | TK | XC | PEG/PEO |
| | distribution | | | 1st | 1st | 2nd | 2nd | 1st | 1st | content in |
| | d10 | d50 | d90 | HR | HR | HR | HR | HR | HR | dry composition |
| | [μm] | [μm] | [μm] | [° C.] | [%] | [° C.] | [%] | [° C.] | [%] | [% by wt] |
| PPS | n.d. | n.d. | n.d. | n.d. | n.d. | 275.6 | 38.5 | 221.8 | 40.6 | n.d. |
| without | | | | | | | | | | |
| additive | | | | | | | | | | |
| PPS-01 | 3.9 | 6.0 | 56.2 | 280.9 | 37.2 | 279.2 | 41.3 | 232.9 | 39.4 | 0.034 |
| PPS-02 | 3.6 | 5.3 | 34.1 | 277.2 | 40.9 | 278.3 | 44.5 | 232.5 | 42.9 | 0.137 |
| PPS-03 | 4.8 | 12.9 | 73.7 | 278.2 | 35.2 | 277.7 | 40.8 | 231.1 | 40.5 | 0.325 |
| PPS-04 | 5.5 | 18.5 | 68.9 | 279.2 | 36.2 | 277.6 | 40.0 | 231.0 | 39.2 | 0.307 |
| PPS-05 | 7.7 | 26.2 | 69.7 | 278.8 | 36.3 | 277.2 | 40.6 | 231.2 | 40.1 | 0.393 |
| PPS-06 | 10.8 | 41.2 | 107.7 | 280.2 | 37.0 | 277.6 | 40.2 | 231.4 | 39.2 | 0.417 |

The PEG or PEO content in the dry compositions was determined by means of DSC (DIN EN ISO 11357) on a DSC measuring instrument (Mettler Toledo DSC823). The evaluation was carried out with the aid of STARe 15.0 software. The method and/or data for the evaluation are shown in Table 14. The PEG or PEO content in the dry compositions is recorded in Table 13.

TABLE 14
Detailed description of the DSC method for the compositions in accordance
with the invention as well as the integration limit and ΔH_{m PEG} of PEG/PEO for the
determination of the PEG/PEO content in the polyphenylene sulphide samples.

| | | | | | PEG/PEO | |
|---|---|---|---|---|---|---|
| | | Start | End | Heating/cooling | integration | |
| Method | Operation | temperature | temperature | rate [K/min] or | limit | ΔH_{m PEG} |
| segment | type | [° C.] | [° C.] | hold time [min] | [° C.] | [J/g] |
| 1 | isothermal | 0 | 0 | 3 min | n.d. | n.d. |
| 2 | dynamic | 0 | 320 | 20K/min | n.d. | n.d. |
| 3 | isothermal | 320 | 320 | 3 min | n.d. | n.d. |
| 4 | dynamic | 320 | 0 | −20K/min | n.d. | n.d. |
| 5 | isothermal | 0 | 0 | 3 min | n.d. | n.d. |
| 6 | dynamic | 0 | 320 | 20K/min | from 55 to 70 | 171 |

The method for calculating the additive content in the composition in accordance with the invention was carried out in accordance with the description of Example 1, in segment 6 of the DSC method. The calculation of the value for the crystallinity by means of DSC produced 112 J/g for theoretically 100% crystalline PPS.

Table 13 clearly shows that the grain size can be adjusted as a function of the molar mass of PEG and PEO. By raising the proportion of PPS from 30% to 40% by weight, the grain size can be increased (cf. PPS-04 and PPS-05) when the ratio of the proportions of PEG with a molecular weight of 20000 and 35000 of 1:1 is retained.

### Example 7

A polyamide 12 (PA12-16) (Grilamide L16 LM, EMS-Chemie, Switzerland) or a polyamide 12 (PA12-20) (Grilamide L20 LM, EMS-Chemie, Switzerland) was mixed together with polyethylene glycol (PEG; molecular weight (MW) 20000 D Clariant, Switzerland) in a ratio of 45% by weight of PA12-16 to 55% by weight of PEG in an extruder (ZSE 27 MAXX, Leistritz Extrusionstechnik GmbH, Nuremburg, Germany) in the molten state (zone temperature: 260° C.). The exact ratios are provided in Table 15. After extrusion, the mixture was cooled on a conveyor belt at a cooling rate of 4° C./second (s) to room temperature and packaged. In order to dissolve the PEG or PEO, a portion of the mixture was then dissolved at 70° C. in water, with stirring (30 g in 150 mL of water), screened in a vibration screening machine (AS200, mesh size 300 μm, Retsch, Haan, Germany) and the <300 μm filtrate was filtered off using a Büchner funnel. The powder cake was washed twice more with 150 mL of water in an Erlenmeyer flask and filtered each time in a Büchner funnel in order to remove the surplus PEG. The powder cake was then dried at 60° C. under 300 mbar for 10 hours in a vacuum dryer (Heraeus, VT6130 P, Thermo Fisher Scientific, Germany). Powder was obtained with the properties shown in Table 16. The determination of the grain size distribution and sphericity (SPHT3) was carried out using a Camsizer XT (Retsch Technology, Software Version 6.0.3.1008, Germany) in accordance with DIN ISO 13322-2, with the X-Flow module in a solution of Triton X in distilled water (3 percent by weight). Evaluation on the basis of Xarea.

TABLE 15
PA12 and PEG 20000 or PEG 35000 and PEO proportions
in the tested compositions, as well as MVR.

| | MVR | | PEG | PEG | |
|---|---|---|---|---|---|
| | (235° C., 2.16 kg) | PA12 | 20000 D | 35000 D | PEO |
| | [cm³/10 min] | [% by wt] | [% by wt] | [% by wt] | [% by wt] |
| PA12-16 | 49.9 | 100 | n.a. | n.a. | n.a. |
| without | | | | | |
| additive | | | | | |
| PA12-20 | 20.3 | 100 | n.a. | n.a. | n.a. |
| without | | | | | |
| additive | | | | | |
| PA12-16-01 | n.d. | 45 | 55 | 0 | 0 |
| PA12-20-01 | n.d. | 45 | 55 | 0 | 0 |

TABLE 16
Grain size distribution and DSC measurements of the tested (dry)
compositions.

| | | | | DSC | | | | | | |
|---|---|---|---|---|---|---|---|---|---|---|
| | | | | | | | | | | PEG/PEO |
| | Grain size | | | TM | XM | TM | XM | TK | XC | content in |
| | distribution | | | 1st | 1st | 2nd | 2nd | 1st | 1st | dry |
| | d10 | d50 | d90 | HR | HR | HR | HR | HR | HR | composition |
| | [μm] | [μm] | [μm] | [° C.] | [%] | [° C.] | [%] | [° C.] | [%] | [% by wt] |
| PA12-16 | n.d. | n.d. | n.d. | 179.0 | 25.7 | 176.5 | 34.8 | 155.5 | 36.6 | n.d. |
| without | | | | | | | | | | |
| additive | | | | | | | | | | |
| PA12-20 | n.d. | n.d. | n.d. | 182.0 | 24.6 | 176.7 | 28.1 | 147.4 | 33.4 | n.d. |
| without | | | | | | | | | | |
| additive | | | | | | | | | | |
| PA12-16-01 | 24.8 | 71.6 | 141.8 | 176.7 | 24.3 | 176.1 | 33.8 | 154.9 | 35.6 | 0.076 |
| PA12-20-01 | 14.6 | 45.2 | 86.4 | 176.4 | 25.2 | 175.7 | 34.8 | 148.6 | 35.2 | 0.283 |

The PEG or PEO content in the dry compositions was determined by means of DSC (DIN EN ISO 11357) on a DSC measuring instrument (Mettler Toledo DSC823). The evaluation was carried out with the aid of STARe 15.0 software. The method and/or data for the evaluation are shown in Table 17. The PEG content of the dry compositions is recorded in Table 16.

The calculation of the value for the crystallinity of polyamide 12, carried out by means of DSC from the melting enthalpy or crystallization enthalpy, produced 209.5 J/g for theoretically 100% crystalline polyamide 12.

TABLE 17
Detailed description of the DSC method for the compositions in accordance
with the invention as well as the integration limit and ΔH_{m PEG} of PEG/PEO
for the determination of the PEG/PEO content in the PA-12 sample.

| | | | | | PEG/PEO | |
|---|---|---|---|---|---|---|
| | | Start | End | Heating/cooling | integration | |
| Method | Operation | temperature | temperature | rate [K/min] or | limit | ΔH_{m PEG} |
| segment | type | [° C.] | [° C.] | hold time [min] | [° C.] | [J/g] |
| 1 | isothermal | 0 | 0 | 3 min | n.d. | n.d. |
| 2 | dynamic | 0 | 250 | 20K/min | n.d. | n.d. |
| 3 | isothermal | 250 | 250 | 3 min | n.d. | n.d. |
| 4 | dynamic | 250 | 0 | −20K/min | n.d. | n.d. |
| 5 | isothermal | 0 | 0 | 3 min | n.d. | n.d. |
| 6 | dynamic | 0 | 250 | 20K/min | from 55 to 70 | 171 |

The method for calculating the additive content in the composition in accordance with the invention was carried out in accordance with the description of Example 1. The PEG/PEO melting enthalpy was determined in segment 6 of the DSC method.

Table 16 clearly shows that the grain size can be adjusted as a function of the melt viscosity of the polyamide 12 employed. With higher melt viscosity, and this also means with higher molar mass, a narrower grain size distribution was obtained when the same proportion of PEG was processed.

1. A composition comprising
(a) at least one polymer,
wherein the polymer is in the form of polymer particles and wherein the polymer is selected from at least one thermoplastic polymer, and
(b) at least one additive,
wherein the at least one additive is in a proportion of at least 0.005% by weight of the composition,
and/or
wherein the additive is in a proportion of at most 2% by weight of the composition.

2. The composition as claimed in claim 1, wherein the additive is selected from at least one semicrystalline polymer, a semicrystalline polyol, a semicrystalline surfactant and/or a semicrystalline protective colloid.

3. The composition as claimed in claim 1, wherein the additive is selected from at least one polyol and/or from at least one polyethylene oxide and/or from at least one polyvinyl alcohol and/or from poloxamers and/or from sodium dodecyl sulphate,
wherein the polyol is selected from at least one polyethylene glycol.

4. The composition as claimed in claim 1, wherein the crystallization temperature of the composition is reduced by at least 2° C. compared with the thermoplastic polymer without additive and/or wherein the difference ΔTK/TM between the crystallization temperature (TK) and the melting temperature (TM) is higher by at least 1° C.

5. The composition as claimed in claim 1, wherein the thermoplastic polymer is selected from at least one polyetherimide, polycarbonate, polysulphone, polyphenylene sulphone, polyphenylene oxide, polyethersulphone, acrylonitrile-butadiene-styrene copolymer, acrylonitrile-styrene-acrylate copolymer, polyvinyl chloride, polyacrylate, polyester, polyamide, polypropylene, polyethylene, polyaryl ether ketone, polyether, polyurethane, polyimide, polyamide imide, polyolefin, polyarylene sulphide, as well as their copolymers and/or at least one polymer blend based on said polymers and/or copolymers.

6. The composition as claimed in claim 5, wherein the at least one of the polyamides is selected from polyamide 6, polyamide 11, polyamide 12, polyamide 46, polyamide 66, polyamide 1010, polyamide 1012, polyamide 1112, polyamide 1212, polyamide PA6T/6I, poly-m-xylylene adipamide (PA MXD6), polyamide 6/6T, polyamide PA6T/66, PA4T/46 and Platamid M1757, copolymers thereof and/or wherein the at least one polypropylene is selected from isotactic polypropylene and/or copolymers thereof with polyethylene or with maleic acid anhydride.

7. The composition as claimed in claim 1, wherein the polymer
comprises at least one semicrystalline copolymer and/or a semicrystalline polymer blend.

8. The composition as claimed in claim 7, wherein the polymer and/or the copolymer and/or the polymer blend has a melting temperature of at least approximately 50° C., and/or wherein the polymer and/or the copolymer and/or the polymer blend has a melting temperature of at most approximately 400° C.

9. The composition as claimed in claim 5, wherein the polyaryl ether ketone is selected from the group formed by polyether ketone ketone (PEKK) and/or from the group formed by polyether ether ketone-polyether diphenyl ether ketone (PEEK-PEDEK).

10. The composition as claimed in claim 5, wherein the polyether ketone ketone has the following repeat units
repeat unit A:
repeat unit B:
wherein the ratio of repeat unit A to repeat unit B is approximately 60 to approximately 40.

11. The composition as claimed in claim 5, wherein the polyaryl ether ketone has a melting temperature of up to 330° C., and/or wherein the polyaryl ether ketone has a glass transition temperature of at least 120° C.

12. The composition as claimed in claim 7, wherein the polymer blend comprises a polyaryl ether ketone-polyetherimide, a polyaryl ether ketone-polyetherimide-polycarbonate, a polyphenylene sulphide-polyetherimide and/or a polyetherimide-polycarbonate.

13. The composition as claimed in claim 1, wherein the composition furthermore comprises an auxiliary material.

14. The composition as claimed in claim 1, wherein the composition has at least one anti-agglomeration agent,
wherein the proportion of the at least one anti-agglomeration agent in the composition is at least 0.01% by weight,
and/or
wherein the proportion of the at least one anti-agglomeration agent in the composition is at most 1% by weight.

15. The composition as claimed in claim 1, wherein the composition has a bulk density of at least approximately 350 kg/m3 and/or at most approximately 650 kg/m3.

16. A method for the production of a composition, wherein the method comprises the following steps:
(i) providing at least one polymer, wherein the polymer is selected from at least one thermoplastic polymer,
(ii) mixing the polymer with an additive,
(iii) removing the additive in order to obtain a composition,
wherein the composition has a content of the at least one additive of at least 0.005% by weight of the composition,
and/or
wherein the additive content is at most 2% by weight.

17. A method for the production of an article comprising the steps of:
(i) applying a layer of a composition as claimed in claim 1 on a build chamber,
(ii) selective consolidation of the applied layer of the composition at locations which correspond to a cross section of the object to be produced, and
(iii) dropping the support and repeating the steps of application and consolidation until the component has been completed.

18. A composition obtained by the method as claimed in claim 17.

19. An article obtained in accordance with a method as claimed in claim 17.

20. Use of a composition as claimed in claim 1, by a member from the group consisting of laser sintering, high speed sintering, binder jetting, selective mask sintering, selective laser melting.
